(19) United States
(12) Patent Application Publication
(10) Pub. No.: US 2018/0095542 A1
(43) Pub. Date: Apr. 5, 2018

(54) Object Holder for Virtual Reality Interaction

(71) Applicant: Sony Interactive Entertainment Inc., Tokyo (JP)

(72) Inventor: Dominic Mallinson, Redwood City, CA (US)

(21) Appl. No.: 15/709,413

(22) Filed: Sep. 19, 2017

Related U.S. Application Data
(60) Provisional application No. 62/403,037, filed on Sep. 30, 2016.

(51) Int. Cl. G06F 3/01; G06F 1/16; G06F 3/16; G06F 3/03; G06T 19/00; G06F 3/0481

(52) U.S. Cl. CPC G06F 3/017; G06F 1/163; G06F 3/167; G06F 2203/04804; G06T 19/006; G06F 3/04815; G06F 3/0325

(57) ABSTRACT

Systems and methods for interacting with virtual reality (VR) space using a head mounted display includes detecting a real-world object in a real-world space in which a user is interacting the VR space. An image of the real-world object is presented in the VR space. The image of the real-world object is used to identify presence of the real-world object while interacting with the VR space. Interaction by the user with the real-world object is detected. The VR space is configured to generate a simulated view of the user interacting with a VR object that is mapped to the interaction with the real-world object. The simulated view is presented in the HMD.

### CLAIM OF PRIORITY

The present application claims priority to and the benefit of Provisional Patent Application No. 62/403,037, filed on Sep. 30, 2016, and entitled, “Object Holder for Virtual Reality Interaction”, which is herein incorporated by reference in its entirety.

### RELATED APPLICATIONS

This application is related to U.S. application Ser. No. 14/254,881 filed on Apr. 16, 2014, and entitled, “Systems and Methods for Transitioning between Transparent Mode and Non-Transparent Mode in a Head Mounted Display,” the disclosure of which is herein incorporated by reference in its entirety.

### FIELD OF INVENTION

The present disclosure relates to systems and methods for interacting with an object holder in virtual reality.

### BACKGROUND

Typically, a head-mounted display (HMD) is a portable device worn around the head of a user, such that a display screen of the HMD provided a short distance from the eyes of the user renders images of virtual reality (VR) space for user interaction. Sometimes HMDs provide an immersive experience by blocking the real-world environment to the user, while providing scenes from a virtual world environment on the display screen of the HMD. Other times, HMDs provide a combination of real-world view and scenes from virtual world environment, where the user is able to see images created by a computing device, as well as some real-world view. As the HMDs are being used more and more as personal viewing tools, it would be advantageous to provide additional options for user interaction in the physical space while the user is engaged in the virtual world environment, so as to allow the user to have an immersive gaming experience without exiting the virtual world environment.

It is within this context that embodiments described in the present disclosure arise.

### SUMMARY

The various embodiments described herein include a head mounted display (HMD) that is capable of locating real-world objects, such as a cell phone, a drink, etc., in a real-world space in which the user of the HMD is operating, using VR objects to represent the real-world objects inside a virtual reality (VR) space and allowing interaction with the real-world objects using the VR objects, without hindering the VR experience or exiting the VR space. The real-world objects may be identified using images from an external camera that is communicatively coupled to the HMD or to a computing device, such as a game console, that is connected to the HMD. Alternately, the real-world objects may be identified using images from a forward facing image capturing device (e.g., camera) mounted on the HMD. Inertial Measurement Unit (IMU) sensors that are available in the HMD may provide additional data that can be used with the images from the external camera and/or the forward facing camera to identify the location of the real-world objects in the physical space (i.e., real-world space). The tracking of the real-world objects may be done while the user is viewing images or interacting in the VR space and does not need the user to remove his HMD.

The advantages of the various embodiments include enabling a user to interact with real-world objects identified in the physical space without the user having to remove the HMD. For example, a user is immersed in a VR environment rendering on the display screen of the HMD, images for which are provided by an executing video game. During game play of the video game, the user may want to drink from a drinking cup or a soda can, answer his cell phone, etc. The embodiments allow the HMD to identify the real-world objects in the physical space in which the user wearing the HMD is operating. The identified real-world objects are introduced into the VR space as VR objects, so as to allow the user to interact with the identified real-world objects through the VR objects. The HMD system provides location information of each of the identified real-world objects using images captured by the external camera, forward facing camera of the HMD, and data provided by the various sensors distributed in the HMD. When the user desires to interact with a specific real-world object, the location information is used to guide the user to the specific real-world object in the physical space.

Another advantage is that when the user is interacting with the real-world object, rendering of the images of the VR environment may be automatically paused or a speed of rendering of the images may be reduced, upon detecting the user interacting with the real-world object, to allow the user to interact with the real-world object. Once the user is done interacting with the real-world object, the rendering of the images from the VR environment may be resumed. This feature allows the user to fully enjoy the VR experience without fear of missing out on any portion of the VR experience during the time the user interacts with the real-world object.

In one implementation, a method for interacting with a virtual reality space using a head mounted display, is disclosed. The method includes detecting a real-world object in a real-world space in which the user is interacting with the virtual reality (VR) space rendered on a display screen of the head mounted display (HMD). The real-world object is identified using an indicator that is disposed on the real-world object. An image of a VR object that is mapped to the real-world object is presented in the VR space. The image of the VR object is provided to indicate presence of the real-world object in the real-world space while the user is interacting with the VR space. User interaction with the real-world object in the real-world space is detected and, in response, a simulated view of a hand of the user interacting with the real-world object is generated. The simulated view includes an image of a virtual hand of the user interacting with the VR object that corresponds to the hand of the user interacting with the real-world object. The simulated view is presented on the display screen of the HMD while the user is interacting in the VR space. The simulated view allows the user to determine a location of the real-world object in relation to the user and to use the location to reach out to the real-world object, while continuing to interact with the images from the VR space.

In another implementation, a method is disclosed. The method includes identifying one or more real-world objects present in a real-world space in which a user wearing a head mounted display (HMD) is operating. The identification of the real-world objects includes determining location and orientation of each of the real-world objects in the real-world space. Orientation of the user wearing the HMD is detected as the user interacts with the images in the VR space. Images of one or more VR objects that correspond with the real-world objects presented in a field of view of the HMD worn by the user, is provided for rendering on the display screen of the HMD. The images of the one or more VR objects presented in the VR space are adjusted dynamically to correlate with a change in the field of view of the HMD worn by the user. User interaction with a real-world object present in the real-world space, is detected, and in response, a view of the user interacting with the real-world object is generated for rendering on the display screen of the HMD. The generated view provides relative position of the real-world objects within the field of view to allow the user to interact with a specific real-world object.

In yet another implementation, a method is disclosed. The method includes identifying one or more real-world objects in a physical space in which a user wearing a head mounted display (HMD), is operating. The HMD is configured to present a list of the one or more real-world objects that are detected in the physical space, on the display screen of the HMD during rendering of the images from the VR space. Selection of a real-world object from the list for user interaction is detected. In response to the selection, a position of the real-world object in relation to a field of view of the HMD worn by the user is determined. An image of a VR object that is mapped to the real-world object selected for user interaction is presented in the VR space currently rendering on the display screen of the HMD, when the real-world object selected is in the field of view of the HMD. The image of the VR object is presented to enable the user to determine location of the real-world object in relation to the user in the real-world space. User interaction with the real-world object in the real-world space is detected and, in response, a simulated view of a hand of the user interacting with the real-world object is generated. The simulated view includes an image of a virtual hand of the user interacting with the VR object that corresponds to the hand of the user interacting with the real-world object. The simulated view is presented on the display screen of the HMD while the user is interacting in the VR space to enable the user to determine the position of the real-world object in relation to the user wearing the HMD.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 illustrates a system for interactive game play of a video game, in accordance with an embodiment described in the present disclosure.

FIG. 2A is an example rendition of a physical space in which the user is interacting with images in a virtual reality space provided on a display screen of the HMD, in accordance with an embodiment.

FIG. 2B is an example rendition of an informational message provided in a virtual reality space while the user is interacting with the content of the virtual reality space, in accordance with an embodiment of the present disclosure.

FIG. 2C is an alternate example of rendering an informational message in a virtual reality space while the user is interacting with the content of the virtual reality space, in accordance with an embodiment of the present disclosure.

FIGS. 3A, 3B illustrate variation of visual, identifiable marker elements of a real-world object that may be used to identify the real-world object, in accordance with different embodiments of the present disclosure.

FIGS. 3C, 3D illustrate variation of visual, identifiable marker elements of a different real-world object that are used to identify the different real-world object, in accordance with different embodiments of the present disclosure.

FIG. 4A illustrates an exemplary view of a virtual reality environment in which an image of real-world object is introduced as a floating message, in accordance with an embodiment of the disclosure.

FIG. 4B illustrates a view of a virtual reality environment that includes an image of a user interacting with a real-world object that was introduced as a floating message, in accordance with an embodiment of the disclosure.

FIG. 4C illustrates a view of a virtual reality environment rendering on a display screen of the HMD while a user interacts with the real-world object, in accordance with an embodiment of the disclosure.

FIG. 4D illustrates a view of a virtual reality environment rendering on the HMD with a portion of a display screen that has transitioned to a transparent mode to allow a user to view the real world environment to enable the user to interact with a real-world object, in accordance with an embodiment of the disclosure.

FIG. 4E illustrates a view of a virtual reality environment rendering on the HMD that includes an image of a user interacting with a real-world object, in accordance with an alternate embodiment of FIG. 4C. FIG. 4E-1 illustrates a view of a virtual reality object that is re-branded within the VR space during the user interaction with the real-world object, in accordance with an embodiment of the invention.

FIGS. 5A-5C illustrate exemplary view of actions of a user with a real-world object that was introduced within the virtual reality environment, in accordance with an embodiment of the disclosure.

FIGS. 5D-5F illustrate different ways the real-world object is represented when introduced into the virtual reality environment, in accordance with different embodiments of the disclosure.

FIG. 5G illustrates a view of a visual alert provided in the virtual reality environment in response to a user wearing the HMD approaching an obstacle, in accordance with an embodiment of the disclosure.

FIGS. 6A-6C illustrate the transitioning of a portion of a display screen of the HMD to transparent mode to enable a user to view a portion of real-world environment when interacting with images from a virtual reality space, in accordance with an embodiment of the disclosure.

FIG. 7A illustrates flow of operations of a method used for interacting with a virtual reality space using a head mounted display, in accordance with an embodiment of the invention.

FIG. 7B illustrates flow of operations of an alternate method used for interacting with a virtual reality space using a head mounted display, in accordance with an embodiment of the invention.

FIG. 8 illustrates various components of a head mounted display (HMD), in accordance with an embodiment of the present disclosure.

FIG. 9 illustrates an embodiment of Information Service Provider architecture, in accordance with an embodiment of the disclosure.

### DETAILED DESCRIPTION

Systems and methods are described for introducing real-world objects in a virtual reality (VR) space of an interactive application currently rendering on a display screen of a head mounted display (HMD) and allowing a user to interact with the real-world objects. Information provided in the VR space can be used to identify and locate the real-world object in the real-world space. Interaction with the real-world objects may be done without requiring the user to remove the HMD and without hindering the VR experience of the user.

In some embodiments, images of the real-world objects in a physical space in which a user wearing the HMD is operating are captured by one or more cameras that are external to the HMD. These images are used to identify the real-world objects and to introduce corresponding VR objects into the VR space. Location of the real-world object in relation to the user is determined using the images from the external cameras that are configured, for example, to capture the depth details. The location of the real-world objects may be verified using one or more forward facing cameras of the HMD. The location data and the images captured by the external camera(s) are used to guide the user toward specific ones of the real-world objects so that the user can interact with the real-world object.

User interaction may include moving a hand of the user toward the real-world object, using the hand to touch the real-world object, moving the real-world object toward the user to allow the user to interact, etc. In cases where the real-world object is being moved toward the user, such movement may be used to transition a portion of a display screen of the HMD to transparent view so that the user may be able to view the real-world object while interacting. In alternate cases, the display screen may be kept opaque while allowing the user to interact with the real-world object. In some embodiments, the HMD may alert the user when the user is approaching a real-world object or obstacle in the physical space while the user is interacting in the VR space. The alert may be presented as an image within an interactive zone highlighting a particular body part (e.g., hand, face, leg, etc.) of the user approaching the real-world object or obstacle. Intensity of the alert in the interactive zone may be increased as the user gets closer to the real-world object or the obstacle and reduced as the user moves away from the real-world object or obstacle. With the general understanding of the disclosure, specific details of the disclosure will be described with reference to the various drawings.

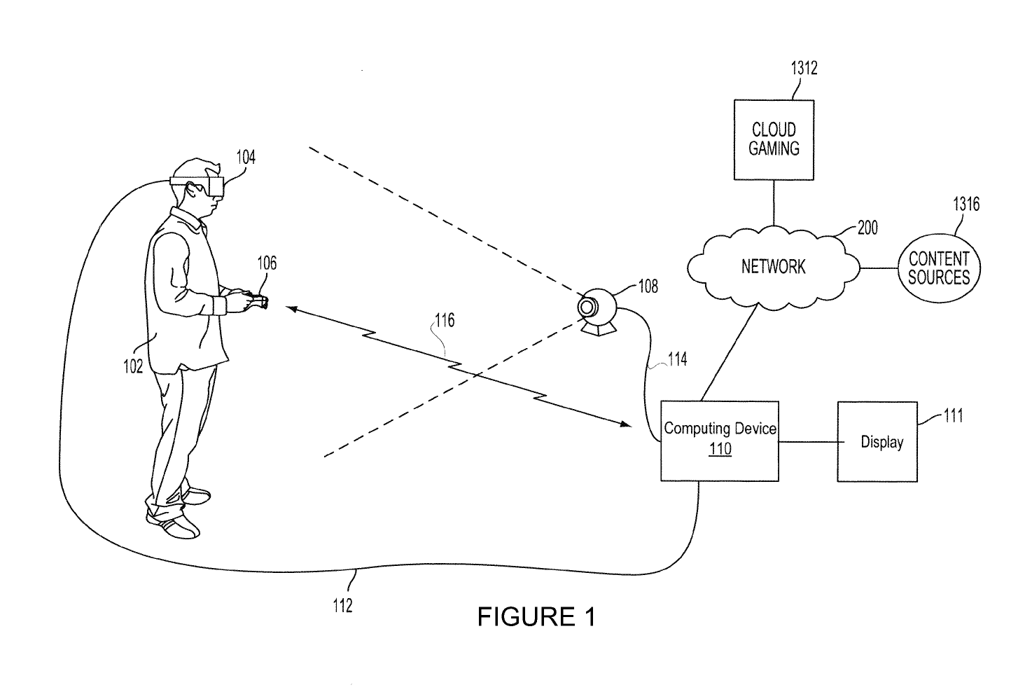

FIG. 1 illustrates a system that is used for interacting with an interactive application, such as game play of an interactive video game, in accordance with an embodiment described in the present disclosure. Although the various embodiments will be discussed with reference to interacting with a video game application, it should be noted that the embodiments may be extended to interacting with any interactive application. A user 102 is shown wearing a head mounted display (HMD) 104. The HMD 104 is worn in a manner similar to glasses, goggles, or a helmet, and is configured to render interactive scenes of a video game to the user 102. The HMD 104 provides an immersive experience to the user 102 by virtue of its provision of display mechanisms (e.g., optics and display screens) in close proximity to eyes of the user 102 and the format of content that is delivered to the HMD 104. In one example, the HMD 104 provides display regions in front of each eye of the user 102 and the display regions occupy large portions or even the entirety of a field-of-view of the user 102.

In one embodiment, the HMD 104 is connected to a computing device 110. The connection to computing device 110 may be wired or wireless (as shown by arrow 116). The computing device 110, in one embodiment, is any general or special purpose computer, including but not limited to, a game console, a personal computer, a laptop, a tablet, a mobile device, a smart phone, a tablet, a thin client, a set-top box, a media streaming device, a smart television, etc. In some embodiments, the computing device 110 may be located locally or remotely from the HMD 104. In embodiments in which the computing device 110 is remotely located, the HMD 104 connects directly to the computing device 110 over a network 200, (e.g., the Internet, an Intranet, a local area network, a wide area network, etc.) which allows for interaction, (e.g., cloud gaming) without the need for a separate local computing device. For example, the computing device 110 executes a video game and outputs the video and audio from the video game for rendering by the HMD 104. In some implementations, depending on the system set up, the computing device 110 is sometimes referred to herein as a client system, which in one example is a video game console.

The computing device 110, in some embodiments, runs emulation software. In a cloud gaming embodiment, the computing device 110 is remote and is represented by a plurality of computing services that are virtualized in data centers (i.e., game systems/logic are virtualized). Data generated from such computing services are distributed to the user 102 over the computer network 200.

The user 102 operates a hand-held controller 106 to provide input for interactive application executing on the computing device 110. The hand-held controller 106 includes interactive elements that can be used to provide the input to drive interaction within the interactive application, such as the video game. A camera 108 is provided external to the computing device 110 and the HMD 104, and is used to capture image of a physical space, e.g., a real-world environment, etc., in which the user 102 is located and is interacting with the interactive application that is providing content for rendering to the HMD 104. For example, the camera 108 may be used to capture images of the real-world objects that are located in the physical space, the hand-held controller 106, and the user that are within a capturing angle of the camera 108. In some embodiments, the camera 108 captures images of marker elements that are on the HMD 104 and the hand-held controller 106. In some embodiments, the images may capture light emitted by light sources, e.g., light emitting diodes (LEDs), disposed on the HMD and/or the hand-held controller 106. In other embodiments, marker elements including passive markers, such as reflective tape, colored markers, distinct patterns, etc., may be provided on the HMD 104 and/or on the hand-held controller 106 and the camera 108 may capture these marker elements. In some embodiments, some of the real-world objects in the physical space in the vicinity of the user may include such passive marker elements making them identifiable. The camera 108 may be able to capture images of such identifiable real-world objects that fall in the view of the camera 108.

The camera 108 sends image data for the captured images via the communication link 114 to the computing device 110. A processor of the computing device 110 processes the image data received from the camera 108 to determine a position and an orientation of the various real-world objects identified in the images, including HMD 104, the controller 106, identifiable real-world objects and the user 102. Examples of a processor include an application specific integrated circuit (ASIC), a programmable logic device (PLD), a central processing unit (CPU), a microprocessor, a multi-core processor, or any other processing unit, etc. In another embodiment, the camera 108 sends image data for the captured images via a communication link (not shown) to the HMD 104 for processing. The communication link between the camera 108 and the HMD 104 may be wired or wireless link. A processor of the HMD 104 processes the image data transmitted by the camera 108 to identify the various real-world objects and to determine position and orientation of the various identified real-world objects. The processed image data may be shared by the HMD 104 with the computing device 110.

Examples of the camera 108 include a depth camera, a stereoscopic camera, a pair of cameras with one of the pair being an RGB (red, green, and blue) camera to capture color and the other of the pair being an infra-red (IR) camera to capture depth, a camcorder, a video camera, a digital camera, or any other image capturing optical instrument capable of recording or capturing images, etc. In cases where a single external camera 108 is used, additional cameras on the HMD 104 (e.g., forward facing camera) may be engaged to provide depth data. In one embodiment, the hand-held controller 106 includes marker elements or other indicators, such as a light (or lights), a tag, etc., that can be tracked to determine its location and orientation. Additionally, as described in further detail below, in one embodiment, the HMD 104 includes one or more lights, indicators, or other marker elements, which may be tracked to determine the location and orientation of the HMD 104 in substantial real-time, while a virtual environment is being rendered on the HMD 104.

The hand-held controller 106, in one embodiment, may include one or more microphones to capture sound from the real-world environment. Sound captured by a microphone or microphone array is processed to identify a location of a sound source in the real-world environment. Sound from an identified location is selectively utilized or processed to exclusion of other sounds not from the identified location. Similarly, the HMD 104 may include one or more microphones to capture sound from the real-world environment. The sound captured by a microphone array may be processed similar to the hand-held controller 106 to identify location of a sound source. Furthermore, in one embodiment, the HMD 104 includes one or more image capturing devices (e.g. stereoscopic pair of cameras), an infrared (IR) camera, a depth camera, and combinations thereof to capture images of various attributes of the user, in addition to capturing images of the real-world environment in which the user is operating. Similarly, the hand-held controller 106 may include one or more image capturing devices to capture images of the real-world environment, and of the user.

In some embodiments, the computing device 110 executes games locally on processing hardware of the computing device 110. The games or content is obtained in any form, such as physical media form (e.g., digital discs, tapes, cards, thumb drives, solid state chips or cards, etc.) or by way of download from the computer network 200.

As mentioned earlier, in some implementations, the computing device 110 functions as a client in communication over the computer network 200 with a cloud gaming provider 1312. The cloud gaming provider 1312 maintains and executes the video game being played by the user 102. The computing device 110 transmits inputs from the HMD 104 and the hand-held controller 106 to the cloud gaming provider 1312, which processes the inputs to affect the game state of the video game being executed. The output from the executing video game, such as video data, audio data, visual data, and haptic feedback data, is transmitted to the computing device 110. The computing device 110 further processes the data before transmission to relevant devices, such as HMD 104, controller 106, etc., or directly transmits the data to the relevant devices. For example, video and audio streams are provided to the HMD 104, whereas a vibration feedback (i.e., haptic feedback) is provided to the hand-held controller 106.

In one embodiment, the HMD 104 and the hand-held controller 106 are networked devices that connect to the computer network 200 to communicate with the cloud gaming provider 1312. For example, the computing device 110 is a local network device, such as a router, that does not otherwise perform video game processing, but facilitates passage of network traffic. The connections to the computer network 200 by the HMD 104 and the hand-held controller 106 are wired or wireless.

In some embodiments, content rendered on the HMD 104 or on a display device 111 connected to the computing device 110, is obtained from any of a plurality of content sources 1316 or from the cloud gaming system 1312. Example content sources can include, for instance, internet websites that provide downloadable content and/or streaming content. In some examples, the content can include any type of multimedia content, such as movies, games, static or dynamic content, pictures, social media content, social media websites, virtual tour content, cartoon content, news content, etc.

In one embodiment, the user 102 is playing the video game executing on the computing device 110 and content for the video game is being rendered on the HMD 104, where such content is immersive three-dimensional (3D) interactive content. While the user 102 is playing, the content on the HMD 104 may be shared to the display device 111. In one embodiment, the content shared to the display device 111 allows other users proximate to the user 102 or remote to watch along during game play of the user 102. In some embodiments, another user viewing the game play of the user 102 on the display device 111 participates interactively with user 102 while the user 102 is playing the video game. For example, the other user is not wearing the HMD 104 but is viewing the game play of user 102 that is being shared on the display device 111. The other user may be another player playing the video game or may be a spectating user. As such, the other user may control characters in the game scene, provide feedback, provide social interaction, and/or provide comments (via text, voice, actions, gestures, etc.), or otherwise socially interact with the user 102.

Interactive scenes from the video game are transmitted to the HMD 104 for display on one or more display screens of the HMD 104, which is worn by the user 102 on his/her head and covers eyes of the user 102. Examples of the display screens of the HMD 104 include a display device that displays virtual reality (VR) images or augmented reality (AR) images. The computing device (e.g., game console) 110 is coupled to the HMD 104 via a communication link 112. Examples of a communication link, as described herein, may be a wired link, e.g., a cable, one or more electrical conductors, etc., or a wireless link, e.g., Wi-Fi™, Bluetooth™, radio frequency (RF), etc. Thus, the camera 108 is coupled to the game console 110 via a communication medium 114, which may be wired or wireless and may also be communicatively coupled to the HMD 104 through wired or wireless link (not shown). Similarly, the hand-held controller 106 is coupled to the game console 110 via a communication link 116, which may be wired or wireless link.

The game console 110 executes a game code to generate image data of the video game. The image data is transferred via the communication link 112 to the HMD 104 for rendering images on the one or more display screens of the HMD 104. The user 102 views the images that are displayed on the HMD 104, and uses the hand-held controller 106 to provide input to the video game. The user 102, during the play of the video game, may move from one location to another in a real-world environment, e.g., a room, a floor of a building, office, a house, an apartment, etc. The user 102 may also move the hand-held controller 106 and/or select one or more buttons of the hand-held controller 106 as part of user interaction with the video game. When the one or more buttons of the hand-held controller 106 are selected, one or more input signals are generated by the hand-held controller 106. Alternately or in addition to providing input using the hand-held controller 106, the user 102 may select one or more buttons or provide inputs through an input surface provided on the HMD 104. The user interactions at the HMD 104 are processed to generate input signals of the HMD 104.

As the user interacts with the video game using the hand-held controller 106, the input signals are sent from the hand-held controller 106 via the communication link 116 to the game console 110. The processor of the game console 110 determines a next game state in the game code of the video game from the input signals, the position and orientation of the HMD 104, and/or the position and orientation of the hand-held controller 106. The game state includes adjustment to position and orientation of various objects, images within a virtual reality (VR) scene of the video game to be displayed on the HMD 104. The VR scene is formed by a number of virtual objects, colors, textures, intensity levels, locations of the virtual objects, a width, a length, a dimension, a background, a size of the virtual objects, etc. Examples of the virtual objects, depending on a context of the video game, may include a car, an avatar, a house, a dog, a sword, a knife, a gun, or any other object that may or may not exist in the real world, etc.

In some embodiments, instead of the hand-held controller 106 of the shape shown in FIG. 1A, hand-held controllers of other shapes or forms, e.g., sword-shaped hand-held controller, a gun-shaped hand-held controller, a stick-shaped hand-held controller, a MOVE™ hand-held controller, a wearable controller, such as a wearable glove, etc., may be used by the user 102 to provide input to the video game.

In some embodiments, the HMD 104 and the hand-held controller 106 may include position and orientation measurement devices, such as inertial sensors, proximity sensors (e.g., ultrasonic sensors, etc., to detect ultrasonic signals), etc., in addition to the cameras or image capturing devices, to detect various attributes (e.g., position, orientation) of the various real-world objects including the hand-held controller 106, the HMD 104. As mentioned earlier, the real-world objects may be identified using identifiable markers of the real-world objects. The external camera 108 may capture the images of the real-world objects using the identifiable markers disposed thereon. Further, the cameras disposed on the HMD (e.g., outward facing cameras) may be used for verification and also to determine depth of the various real-world objects captured in the images by camera 108. For example, the HMD 104 has one or more depth cameras and each depth camera has a lens that faces the real-world environment to capture images of real-world objects including images of the hand-held controller 154. An example of a proximity sensor is a sensor that emits an electromagnetic radiation, e.g., infrared (IR) radiation, radar signals, etc., and senses changes in a return signal, which is a signal returned from the real-world object in the room. Examples of the inertial sensors include magnetometers, accelerometers, and gyroscopes. Similarly, the hand-held controller 106 includes one or more position and orientation measurement devices for determining a position and orientation of the hand-held controller 106.

The various sensors of the HMD 104 and the hand-held controller 106 generate electrical signals based on movement of the HMD 104, hand-held controller, and the user 102, which are then communicated to the computing device 110. The processor of the computing device 110 computes the position and orientation of the HMD 104, the hand-held controller and the user 102 in relation to the real-world objects identified in the physical space in the vicinity of the user 102. The position and orientation of the various devices, the real-world objects are determined while the user wearing the HMD 104 is interacting in the VR space provided by the video game. In some embodiments, the images captured by the image capturing devices of the HMD 104 and the images captured by the external camera 108 are interpreted to determine depth at which the real-world objects including the HMD 104, hand-held controller 106, the user 102 are in relation to one another.

In various embodiments, instead of the game console, any other type of computing device 110 may be used.

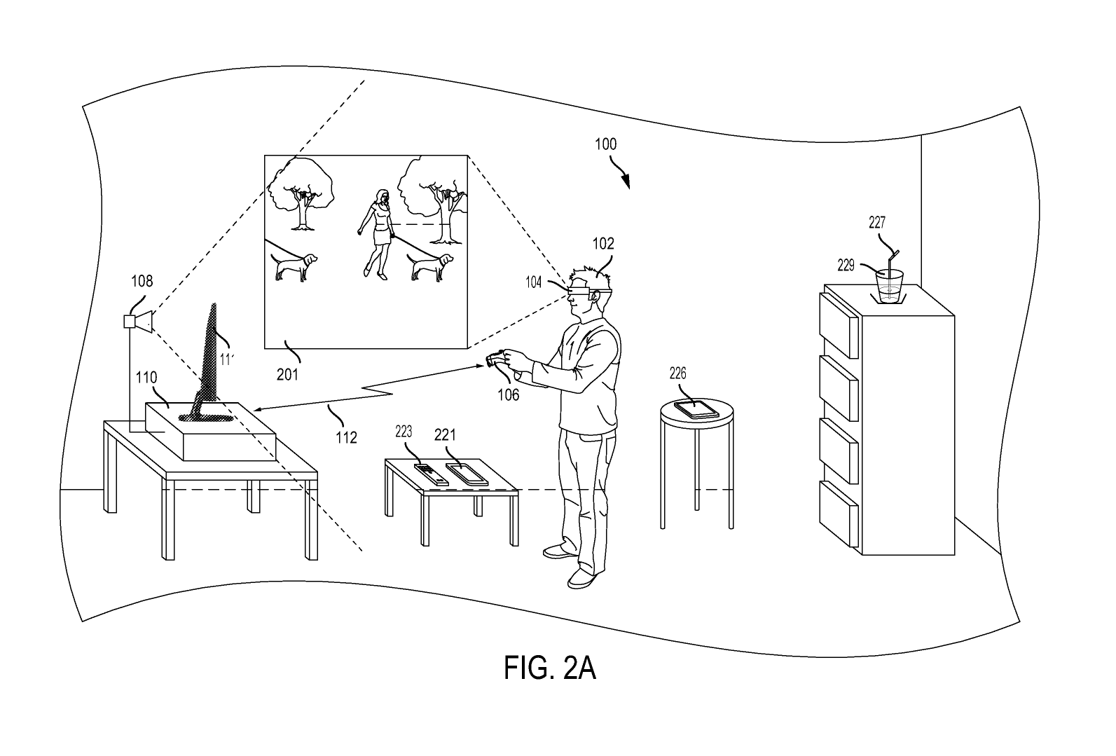

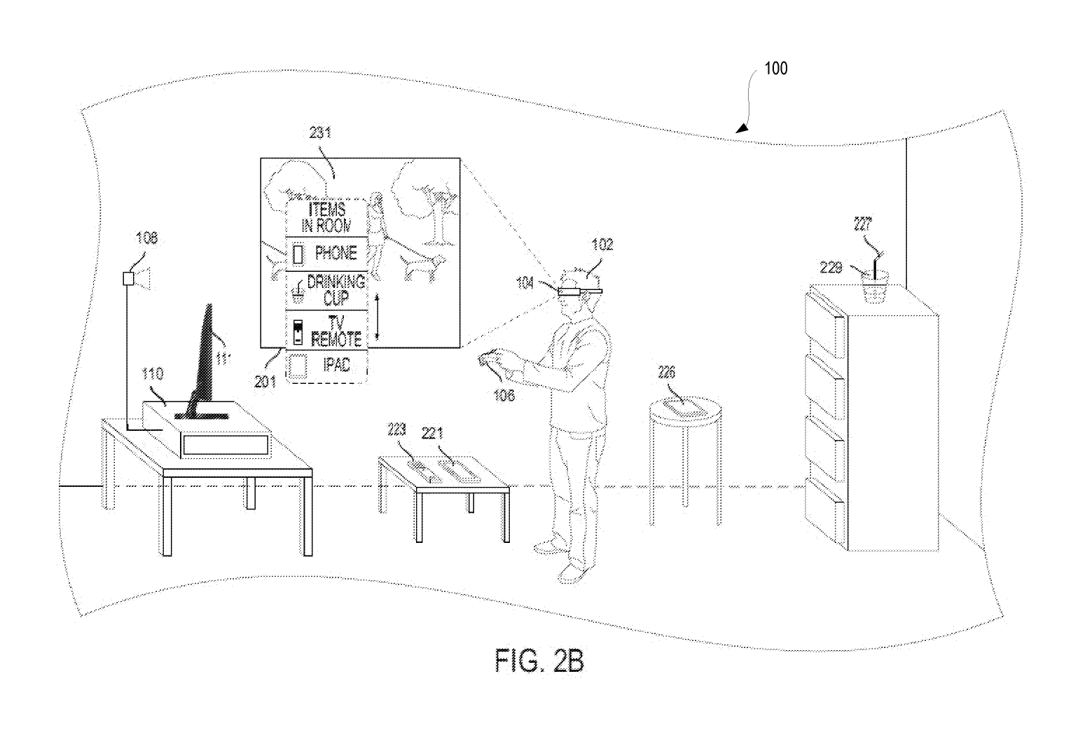

FIG. 2A illustrates a view of a real-world environment (i.e., physical space) 100 in which user 102 is operating and a view of virtual reality (VR) space content currently rendering on the HMD 104, in one embodiment. The real-world environment includes real-world objects, such as tables, chest of drawers, walls of a room in which the user is operating, etc. Other objects in the real-world environment 100 may be identified using identifiable marker elements (e.g., bar code, Quick Response (QR) code, distinct patterns, color coded patterns, reflective tapes, or other passive marker elements) that are disposed or defined on the objects or are associated with the objects. In some embodiments, the identifiable marker elements may be provided on the objects. In other embodiments, the identifiable marker elements may be provided on a secondary object that holds or receives the object, such as a cell phone case for a cell phone, a notebook case for a notebook computing device, a coaster on which a drinking cup is placed, a holder for the drinking cup, etc. The secondary object may also be provided within a real-world object. For example, a straw that is used to sip a drink from a drinking cup or a soda can, may include the identifiable marker element, which can be used to identify the drink or the drinking container (i.e., cup or can). In this example, the soda can or the drinking cup may not have the identifiable marker element but may be identified based on the marker element on the straw that is used to sip the drink in the drinking cup or the soda can. These identifiable marker elements on the secondary objects are used to identify the real-world objects. In some embodiments, the identifiable marker elements are associated with pre-defined object identifiers. In alternate embodiments, the identifiable marker elements are placed on objects and object identifiers are defined for the marker elements.

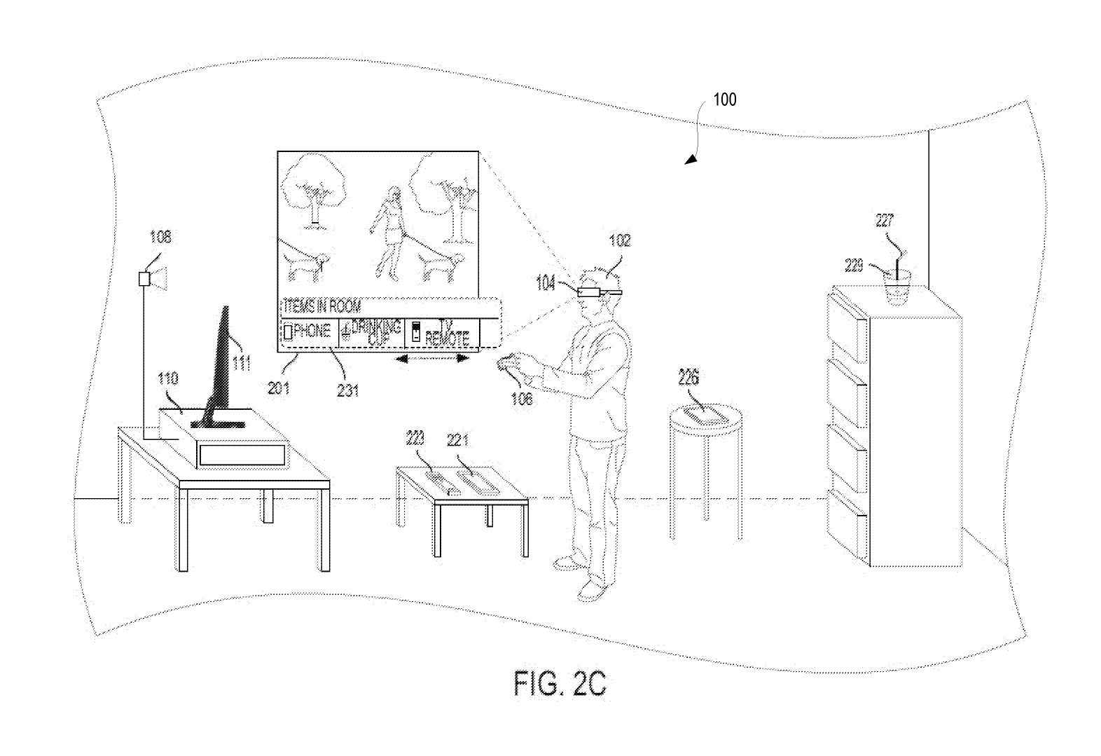

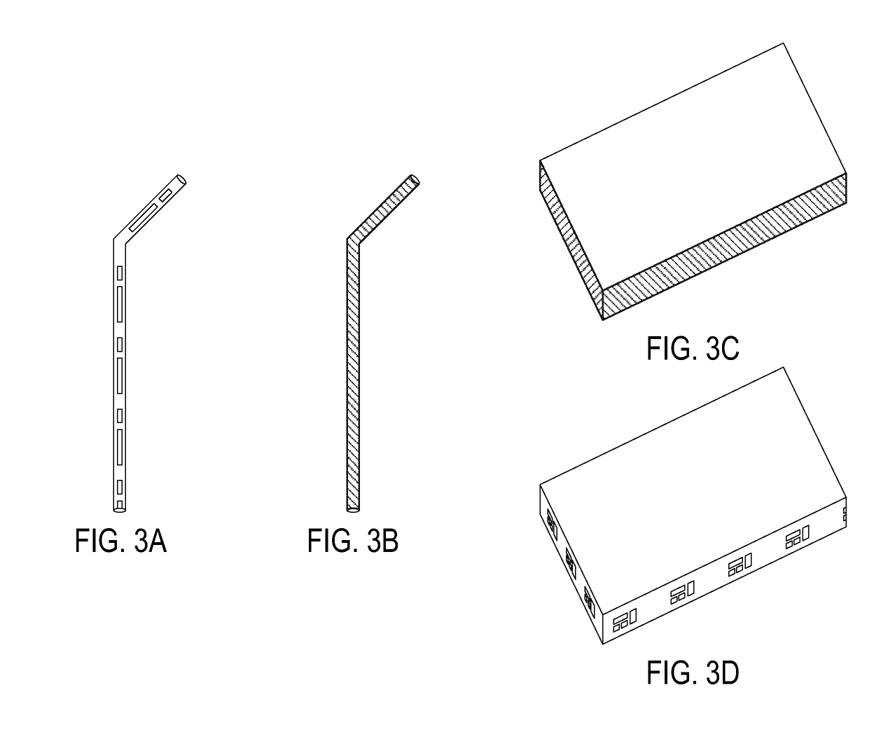

FIGS. 3A-3D illustrate examples of marker elements that may be used to identify real-world objects, in different embodiments. For example, a straw may have a marker element, such as a distinct pattern of rectangles, as illustrated in FIG. 3A, or may have color coded pattern, as illustrated in FIG. 3B. Either of these patterns, when detected in an image captured by an image capturing device, such as external camera 108 and/or camera disposed on the HMD 104, may use the marker elements on the straw to identify a drinking cup in which the straw is received. Similarly, a cell phone may be received within a cell phone case, which has a distinct color-coded pattern, as illustrated in FIG. 3C, or a distinct geometrical pattern of squares and rectangles, as illustrated in FIG. 3D. It is to be noted that the color-coded patterns or distinct geometrical patterns are examples and other marker elements, such as bar codes, QR codes, reflective tapes, etc., may also be used to distinctly identify the real-world objects.

In some implementations, the object identification may be based on the context rather than precise identification. For example, in the above example of the straw identifying a drinking cup, the drink in which the straw is provided may be contained in a can and not in a cup. However, since the straw is associated with a drink and the container holding the drink does not have any identifiable marker or indicator disposed thereon, the identification of the drinking cup (instead of a can) holding the straw may still be acceptable.

Referring back to FIG. 2A, the images captured by the external camera 108 may be used to identify real-world objects that are associated with distinguishable marker elements. For example, some of the real-world objects with distinguishable marker elements that may be detected by the external camera 108 include a cell phone 221, a remote control 223, an iPad computing device 226, a straw 227 that is inside a drink, and a drinking cup 229. In this example, the drinking cup 229 may be identified by a distinct marker element that is disposed on the drinking cup 229. The aforementioned real-world objects that are identified from the images may be in addition to the identification of commonly occurring objects within a physical space, such as tables, desks, chairs, chest of drawers, sofa, walls, windows, a hand-held controller 106, the HMD 104 and the user 102, etc. The external camera 108 may be a depth camera and the images of the real-world objects captured may provide depth, so that the location and orientation of the real-world objects may be easily determined. Images captured by the external camera 108 may be verified using images captured by a forward facing camera of the HMD 104. Further, the images captured by the forward facing camera of the HMD 104 may be used to precisely locate the real-world objects in the physical space. The identified real-world objects (i.e., objects) are introduced into the VR space as VR objects, for user selection. The introduction of the VR objects that are mapped to corresponding ones of the real-world objects may be based on field of view of the HMD 104 worn by the user, as the user is interacting with the content rendered in the VR space. For example, in FIG. 2A, as the user is facing forward (i.e., toward the game console 110 and the external camera 108, the real-world objects (e.g., iPad computing device 226, the straw 227 and the drinking cup 229) that are behind the user 102 are not introduced as VR objects in the VR space. Instead, the real-world objects—remote control 223 and cell phone 221 that are in the field of view of the HMD 104 are introduced into the VR space as corresponding VR objects. In some implementations, real-world objects that are identified in the physical space in which the user is operating are presented in a list. This list identifies all the real-world objects with identifiable markers in the physical space, irrespective of the location of the real-world objects in relation to the field of view of the HMD 104 worn by the user 102.

FIG. 2B illustrates a view of a VR space that is currently rendering on the display screen of the HMD 104 worn by a user 102, in one embodiment. The list of the real-world objects identified from images of the real-world environment captured by the external camera 108 and verified from images captured by the capturing devices of the HMD 104 (where available), is rendered as an overlay in the VR space. In one embodiment, the list of objects presented in the VR space includes only those objects that are associated with identifiable marker elements although other objects, such as tables, chest of drawers, wall, etc., were also captured in the images. Thus, the list includes cell phone 221, drinking cup 229, TV remote control 223, iPad 226, etc., based on the object identifiers corresponding to the marker elements associated with the objects. In such embodiments, the images captured by the external camera 108 (and the cameras of the HMD 104) may be processed to identify those objects that have object identifiers and filter out the real-world objects that do not have any object identifiers. In the above example, the real-world objects, such as tables, chest of drawers, walls, etc., that do not have any object identifiers associated with them are not included in the list.

The list of identified objects may be presented as a floating image within an interactive zone 231 defined within the VR space. The floating image, in one embodiment, is provided as an overlay in the VR space. The list provides information to easily identify the objects. In some embodiments, the information may include visual indicators of the objects, such as an image of the object, and an object identifier. The image is said to be “floating” as it is configured to follow the user as the user navigates in the VR space and in the real-world environment. The position or orientation of the floating image is provided as an example. The floating image of the list of objects may be provided in the bottom of the display screen, as illustrated in FIG. 2C, at the top of the display screen, anywhere in-between or in any other orientation.

In one embodiment, the list of objects from the real-world environment presented in the VR space may include only those objects that are in the line of sight of the user (i.e., field of view of the HMD worn by the user) and may be dynamically updated based on the direction the user is facing in the real-world environment. For example, if the user is facing forward, as illustrated in FIG. 2B, only those objects that are between the user and the external camera 108 are included in the list while the other objects that are behind the user (i.e., drinking cup 229, straw 227, iPad 226) are not included. This dynamically updated list helps the user in determining which ones of the objects are reachable to the user and the objects positions in relation to the user. In an alternate embodiment, all the objects that were in the line of view of the external camera 108 are included in the list.

The user may select any one of the objects in the list for user interaction. The selection may be done, for example, using buttons or input options on a controller 106 or via voice command or using input options on the HMD 104 or via eye signals. In this example, user selection may be detected at the HMD 104. In another example, the selection may be done by physically reaching out to the object. In this example, user interaction of reaching out may be detected by the external camera 108 and provided to the HMD 104, where the user action is interpreted as user input of selecting the object. In response to the selection of the object, the processor of the HMD 104 may introduce an image of a VR object that is mapped to the real-world object, into the VR space that is currently rendering on the display screen of the HMD 104. The image of the VR object is provided in place of the list. In some implementation where a hand of a user is used to interact with the object in the real-world space, as the hand of the user reaches out to the real-world object, the image of the VR object in the VR space, is highlighted. Further, as the hand of the user moves closer to the real-world object, the highlighting intensity of the VR object is increased in the VR space to indicate the user's selection or object of interest, and as the user's hand moves away from the real-world object the intensity of the highlight is decreased. Instead of highlighting, other means of identifying the object of interest in the VR space may be contemplated. In one embodiment, the image of the VR object is presented as long as the user moving in the real-world environment is facing in a direction in which the real-world object is in the line of sight of the user.

In one embodiment, options may be provided to the user to recall the list of objects at any time during interaction with images from the VR space to enable the user to select another object from the list. Like the list, the image of the object, upon selection, may be introduced into the VR space as a floating image and the floating image is adjusted to move in relation to the movement of the user in the real-world as the user interacts with images from the VR space. For example, if the user moves away from the selected object, the image of the VR object mapped to the selected object is adjusted to render at a distance that correlates with the relative distance of the user to the object in the real-world space. As the user's position or orientation changes, the selected object may no longer be in the line of sight of the user (i.e., field of view of the HMD worn by the user). As a result, in one implementation, the VR object of the selected image may be rendered as a “ghost” image in the VR space to indicate that the real-world object corresponding to the VR object is out of the field of view of the user. If the user moves around and the selected object comes into view, the image of the VR object is adjusted to a regular image to indicate that the selected object is now in the field of view of the user.

In alternate implementation, based on the user's movement, if the selected object moves out of the field of view of the user, the list may be automatically presented to the user as a floating image to allow the user to select another object from the list to interact with, while the user is also interacting with the images from the VR space. In some implementation, the list may include all the objects that were identified in the real world space (i.e., physical space) but with one or more of the real-world objects that are not in line of sight of the user, greyed out. In another implementation, the list may be updated to only include objects that are in the line of sight of the user based on the user's current direction and not include all the objects identified in the real-world space as captured by the camera 108.

In some implementations, if the user's field of view changes, instead of presenting the list, the user may be automatically presented with an image of a VR object corresponding to the real-world object that is line of sight of the user. The image of the VR object may be provided in place of or in addition to the image of the VR object that corresponds with the real-world object selected by the user to interact with, so long as the field of view of the user covers both the objects (i.e., selected object and the object that is come in to view due to movement of the user). For example, if the user looks down, the images in the VR space may be updated to include VR images of one or more real-world objects that are in the user's line of sight, while the image of the selected object continues to render in the same portion of the display screen.

The images presented to the user in the VR space may adjusted by tracking the user's movement in the real-world space. Changes to the user's position and orientation may be detected using the images of the external camera 108 and provided as input to the HMD 104. The HMD 104 processes the position and orientation data of the user and updates the position and orientation of the image of the selected object presented on the screen in relation to the current position and orientation of the user.

For example, when the movement of the user in the real-world environment causes the user to face in a direction where the selected object is not in line of sight of the user, the image of the selected object is removed from the VR space. Depending on the speed of change in the user's direction, the image of the selected object may be faded away gradually or abruptly. Similarly, as the camera detects the user returning to face the selected object, the image of selected object (i.e., VR object) is brought back into focus in the VR space. Such fading out and bringing into focus may continue so long as the object continues to be selected. The external camera 108 may monitor the movement of the user relative to the location and orientation of the selected object and provide appropriate signals to the HMD 104 that causes the HMD 104 to update the image of the object in the VR space. As the user continues to interact with the selected object, images of the user interacting with the object are updated in the VR space.

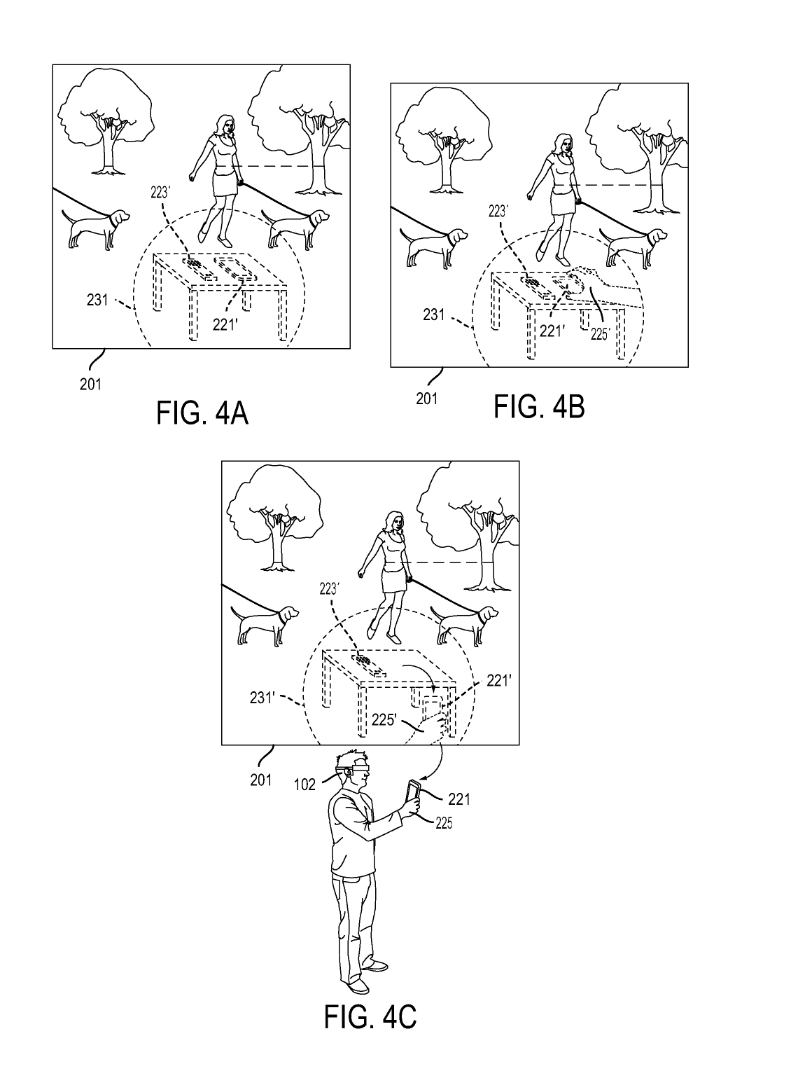

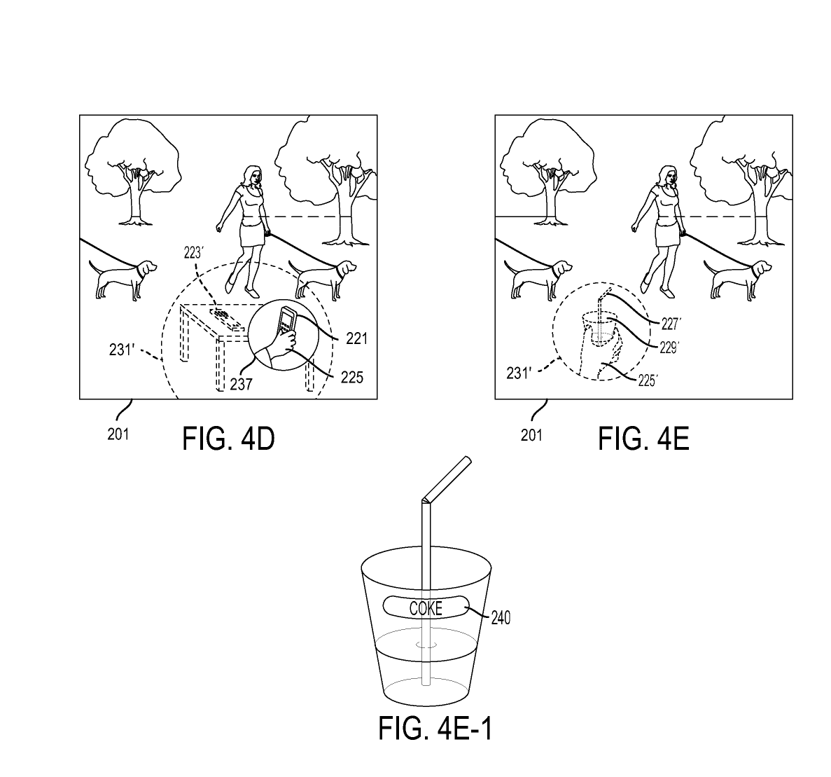

FIGS. 4A-4C illustrate one such embodiment, wherein the VR space provides images that are indicative of the user interacting with the object in the real-world space, in one embodiment of the invention. As illustrated in FIG. 4A, a user selection of an object from the list or through interaction with the real-world object would cause an image of a VR object that is mapped to the selected real-world object, to be introduced into the VR space as a floating image, for example. The image of the object may be presented as a ghost image, a wire-framed image, or as an overlay, for example. FIG. 4A shows a wire-framed image (represented as broken lines) of the selected object that is introduced into the VR space in an interactive zone 231. In one embodiment, an image of a VR object corresponding to the selected object is introduced into the VR space. For example, if the user has selected the cell phone 221 for further user interaction, an image 221′ of the cell phone 221 is introduced into the VR space. In an alternate embodiment, the selected object and any other object in the vicinity of the selected object (i.e., within a pre-defined distance) may be introduced into the VR space. In the above example, along with an image 221′ of the cell phone 221, an image 223′ of a TV remote control 223 that is in the vicinity of the cell phone 221 is also introduced into the VR space in the portion that is defined as the interactive zone 231.

In one embodiment, the image(s) of the selected object and any other object introduced into the VR space are VR generated images. FIG. 4A illustrates an example of the VR generated images of the cell phone 221 and of the TV remote control 223 that are introduced into the VR space as floating images. In one embodiment, the VR images of the cell phone and the TV remote control (221′ and 223′) are shown to be disposed on a table. In this embodiment, the table may have been identified and rendered based on an identifiable marker element associated with the table. The image of the table may be VR generated. In an alternate embodiment, the table may not be shown and only the VR generated image 221′ of the cell phone 221 and, in certain embodiments, the VR generated image 223′ of the TV remote control 223 may be presented as a floating image. The image of the cell phone that is provided in the VR space includes depth information that corresponds with the location of the cell phone with respect to the user in the real-world environment. This depth information may assist the user to locate the cell phone in the real-world environment, for example. The remaining portion of the VR space continues to render images from the video game.

As the user reaches out and grabs the cell phone in the real-world, a simulated view of the user interaction is presented in the VR space. The simulated view includes an image of the user interacting with a VR version of the selected object that maps the user interaction with the real-world object to the user interaction with the VR object. FIG. 4B illustrates one such embodiment, wherein an image of a user's hand is shown to be interacting with the VR generated image of the cell phone 221′. Like the image 221′ of the cell phone 221, the image 225′ of the user's hand 225 that is introduced into the VR space is also VR generated. Although the images are VR generated, the action of the user that is directed toward the selected object in the real-world environment is reflected in the VR generated images presented in the VR space. For example, the VR generated images may show the user's hand reaching toward the cell phone and lifting it from the table.

As the user moves the cell phone toward his face, the image of the cell phone 221′ moves out of the VR space, as shown in FIG. 4C. The VR space may continue to render the image of the TV remote control 223′ at this time. Once the user finishes interacting with the cell phone, the user may return the cell phone to its original position in the real-world environment. In response to detecting the user returning the cell phone to its original position from the images captured by the camera 108, the HMD 104 may re-introduce the image of the VR generated cell phone with the user's hand into the VR space. In one implementation, once the hand 225 of the user releases the cell phone 221 indicating that the user is done interacting with the cell phone 221, the floating image of the cell phone and the TV remote control (221′ and 223′) may be removed from the VR space, allowing the user to view the content rendered in the VR space unhindered. In response to user's completion of interacting with the selected object, in one embodiment, the list of objects may be presented in the VR space.

In one embodiment, as the user brings the cell phone toward his face while continuing to be engrossed with the content in the VR space, a portion of the display screen may be transitioned to transparent view to allow the user to see and interact with the cell phone 221, in one embodiment. FIG. 4D illustrates one such embodiment wherein the images from the camera 108 detect the user grabbing the cell phone 221 in the real-world environment and moving it toward the user's face. The HMD 104 receives the images from the camera 108, analyzes the images and determines that the user is in the process of interacting with the cell phone 221. To assist the user in viewing the cell phone during interaction, the HMD 104 will send out a signal to open a portion 237 of the display screen to transparent view. The portion 237 of the display screen that is transitioned to transparent view corresponds with the direction in which the user's hand is moving in the real-world. FIG. 4D illustrates a view of a display screen of the HMD 104, which includes content from the VR space 201, a portion of the VR generated image of the TV remote control 223′ in the interactive zone 231, and the transparent window 237 that shows a view of the real-world with the user's hand 225 interacting with the cell phone 221.

FIG. 4E illustrates an alternate embodiment wherein the user is interacting with a real-world object. A user may be interested in taking a sip out of a drink while interacting with the content of the VR space (e.g., interactive scenes of a video game) rendering on the HMD 104. In this embodiment, the image that is rendered on the display screen of the HMD is VR space content that includes content from the video game 201 and image of a hand of a user interacting with the drinking cup rendered in the interactive zone 231. It should be noted that in the various embodiments, the images rendered in the interactive zone 231 are simulated view of the selected object and/or user interaction with the selected object from the real-world. Additionally, the interactive zone 231 has been shown with a distinct outline while in reality it may be rendered with or without a distinct outline. The image rendered in the interactive zone 231 includes simulated view of a VR generated image (229′, 227′ and 225′) of the real-world drinking cup 229 and the straw 227 and the user's hand 225′ that is interacting with the drinking cup 229, which is also VR generated. However, it should be noted that the user interaction occurs with the real-world object and the simulated view maps the actual user interaction with the real-world object to the user interaction with the VR generated object. In this embodiment, the HMD 104 does not issue a signal to transition a portion of the screen to a transparent window. This might be due to the fact that the user does not have to view the selected object during interaction as the selected object is a drinking cup and the user interaction is directing the drinking cup with the straw to the user's mouth for taking a sip. Since the user knows where his mouth is, there is no need to provide a view of the real-world in which the object is present.

In one embodiment, user interaction with the real-world object may be used to re-brand the real-world object. The re-branding may be done by the user or by a sponsoring entity (e.g., an advertiser). The re-branding of the real-world object may include associating an identity to the real-world object. For example, if the user is sipping a drink from a soda can or a cup, the soda can or the cup may be re-branded to represent a specific brand of drink (e.g., Coke). FIG. 4E-1 shows one such re-branding, wherein the drinking cup in the simulated view is re-branded 240 to show the Coke sign. Such re-branding may be used to promote a product in the VR space. In some embodiments, the re-branding may be done by the user using audio command. In other embodiments, the re-branding may be done using options provided in the VR space.

In order to determine when to transition a portion of the display screen to transparent view, the HMD 104 identifies the selected object using the object identifier and evaluates the information associated with the selected object to determine the object type and the types of interaction that can be done at the object in the context of the real-world environment. In the above example of a user taking a sip, the object that the user has selected to interact with is identified to be a drinking cup. The types of interaction that can be done with the drinking cup are filling the cup with a drink, sipping out of the cup, emptying the cup, and washing the cup. A current context of the selected object in the real-world environment can be determined by evaluating the image of the selected object. In the above example, it is determined that the type of interaction that can be done is sip from the cup. Such determination is made based on the presence of the straw in the drinking cup, indicating that the straw is present for consumption of the drink held in the cup. Based on the evaluation, the HMD 104 determines that the user is sipping from the cup and, as a result, determines that there is no need to transition a portion of the display screen to transparent view. If, on the other hand, during evaluation, it is determined that the cup is empty and there is straw in the cup, the HMD 104 may transition the portion of the display screen to transparent view so as to allow the user to re-fill the cup. It should be noted that the evaluation is not restricted to images captured by the cameras but can also extend to audio as well.

In some implementations, while the user is interacting with the selected object, the HMD 104 may send a signal to the computing device 110 to reduce the frame rates of the content (e.g., interactive scenes of a video game) that is being transmitted to the HMD 104 for rendering, in one embodiment. In an alternate embodiment, the signal from the HMD 104 may include a request to the computing device 110 to pause the video game during user interaction with the selected object. In response to the pause signal, the computing device 110 may store a game state of the game, and identify a resumption point in relation to the game state from where to resume the video game. In some embodiments, the computing device 110 may rewind the video game a pre-defined number of frames within the context of the game state of the video game to define the resumption point. When the HMD 104 detects completion of the user's interaction with the selected object, the HMD 104 may generate a second signal to the computing device 110 to resume the video game. The computing device 110 services the second signal by resuming the video game from the resumption point.

In an alternate embodiment, the HMD 104 may include sufficient logic to automatically reduce the rendering rate of the frames of the video game during user interaction with the selected object and resume the rendering rate to original speed upon detecting that the user is finished interacting with the selected object. In such embodiment, the frames may be stored in a buffer and presented to the display screen for rendering during and after completion of user interaction with the selected object.

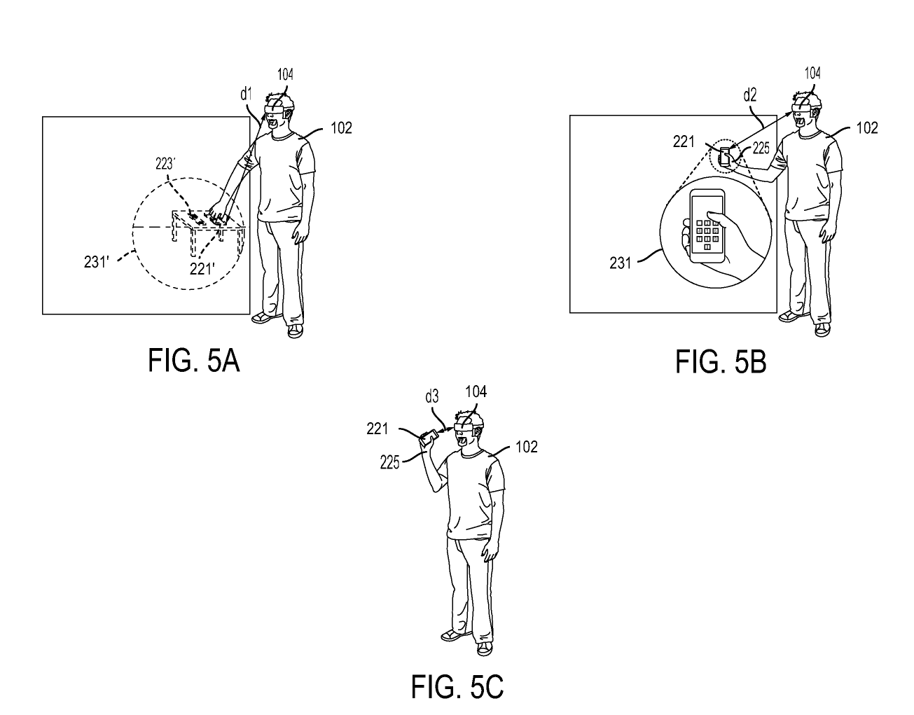

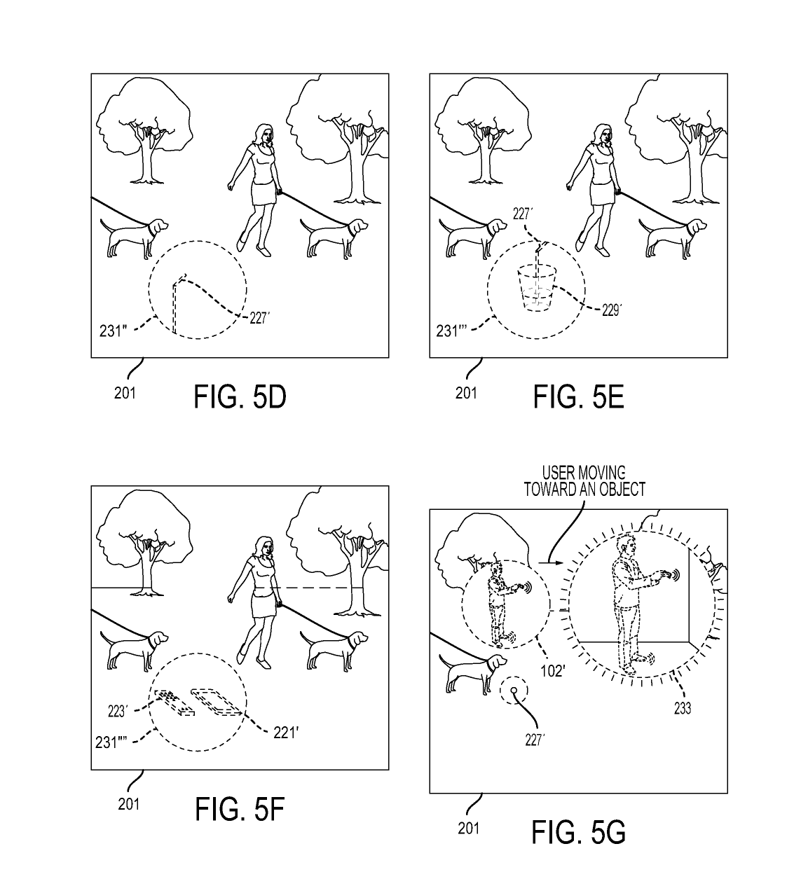

FIGS. 5A-5C illustrate images of a user interacting with the selected object, in one embodiment. The user interacting with the selected object may be captured by the external camera 108. FIG. 5A illustrates the user interacting with a cell phone 221 in the real-world and this interaction is captured and rendered in an interactive zone 231′ using VR generated images (221′, 223′) of the cell phone and the TV remote control that is in the vicinity of the cell phone in the real-world, wherein the interactive zone 231′ is rendering VR generated images. When the user begins to interact with the cell phone 221, the cell phone 221 is computed to be at a distance ‘d1’ from the face of the user. The distance d1 is computed by the external camera 108 by using the ultrasonic emitters of the camera 108. The ultrasonic emitters generate sound waves that are sent toward the cell phone 221 and the user, which reflect back the sound waves. An ultrasonic detector of the external camera 108 detects the reflected sound waves to generate electrical signals. The electrical signals are sent from the sound detector to the processor of the camera 108. The processor of the external camera 108 determines whether an amplitude of the sound waves reflected from the cell phone 221 is greater than an amplitude of the sound waves reflected from the user 102. Using this information, the processor of the external camera 108 may accurately determine the distance between the user and the cell phone, which is then forwarded to the HMD 104 along with the captured images of the real-world environment for the HMD 104 to process.

In an alternate embodiment, radio waves from a radio transmitter may be used to determine the distance between the cell phone 221 and the user 102. Antennas, such as RF antennas, may be provided in the external camera 108 and the HMD 104 to convert the radio waves into electrical signals and vice versa. The radio transmitter supplies an electric current at radio frequency to the antenna and the antenna radiates the electrical energy as radio waves. The radio waves reflected back from the user and the cell phone are received by the antenna, which converts the radio waves into electrical signals and supplies it to a radio receiver. The processor of the external camera 108 interprets the electrical signals from the cell phone 221 and from the user 102 to determine the distance of the cell phone and the user from the external camera 108 and between each other (user, the cell phone).

In some embodiments, the distance d1 between the user and the cell phone as computed by the processor, may be greater than 2 feet. In one embodiment, when the user is out-of-reach of the cell phone, the user may move towards the cell phone and reach out to the cell phone when the user is in the interaction zone (e.g., d1 is about 3-4 ft) of the cell phone.

FIG. 5B illustrates an image of the user as the user grabs the cell phone and moves it towards the user's face in order to interact with the cell phone 221. The distance between the cell phone 221 and the face of the user 102 is now computed to be ‘d2’, wherein d2<d1. During the time the user is interacting with the cell phone 221 (i.e., moving the cell phone toward the user's face), the HMD 104, in one implementation, may continue to render the VR generated image of the cell phone moving toward the user's face. In alternate implementation, the HMD 104 may generate a signal to transition a portion of the display screen to allow the user to view the cell phone, as shown in FIG. 5B. In this implementation, the interactive zone 231 is rendering a view of the real-world environment by rendering the hand of the user 225 interacting with the cell phone 221. As such, VR image 223′ of the TV remote control 223 is removed from rendering on the display screen.

The user continues to move the cell phone to a distance d3, which is closer to the user's face, in order to interact with the cell phone 221, as illustrated in FIG. 5C. The distance d3 is less than distance d2 (FIG. 5B), which is less than distance d1 (FIG. 5A). The interaction may include answering the cell phone, sending text message, etc. The images from the external camera 108 may include the depth data that can be interpreted by the HMD 104. Based on the interpreted depth data, the type of the object, and type of interaction directed toward the object, the HMD 104 may, in some implementations, send a signal to continue to render the hand 225 of the user interacting with the cell phone 221 in the transparent portion of the display screen of the HMD 104 so as to allow the user to view the cell phone during interaction. In some implementations, once the user's hand is close to the user's face indicating that the user is talking on the cell phone, the external camera 108 may determine the context of the user interaction (i.e., the user no longer needs to see the cell phone when he is talking) and send out a signal to the HMD 104 indicating the determined context. The HMD 104 may interpret the signal and may determine that the display screen no longer needs to render the user interaction with the cell phone and may send out a signal to either pause the rendering of the interactive scenes of the content or resume the rendering of the interactive scenes, depending on the state of the user interaction. FIG. 5C illustrates shows one implementation wherein the user continues to view the interactive scenes of the content rendering on the screen. In this implementation, the speed of rendering of the frames of the interactive scenes may be reduced to allow the user to interact with the cell phone (i.e., hold a conversation through the cell phone) and once the user disconnects the cell phone, the speed of rendering of the scenes may be resumed.

FIGS. 5D-5F illustrate different views of the VR space in which an image of an object with identifiable marker element is introduced, in some embodiments of the invention. In FIG. 5D, a straw with identified marker element is introduced into the VR space at the interactive zone 231″. Although the selected object may be a drinking cup and the user interaction is to sip from the drinking cup, the image 227′ that is shown is of the straw 227 that is used to sip a drink from the drinking cup. User interaction may be directed toward the drinking cup that holds the straw 227 and such interaction may be carried out based on the image 227′ of the straw 227. The image 227′ of the straw 227 is a VR generated image.

FIG. 5E illustrates an alternate embodiment, wherein an image of the selected object is rendered in the VR space, based on the user selection and interaction with the selected object. In this embodiment, the selected object may be a drinking cup that holds the straw 227 with identifiable marker, and the user interaction may be directed toward reaching out to the drinking cup and drinking out of the straw 227. Although the straw has the marker element and the drinking cup 229 does not have any identifiable marker element, the image of the selected object rendered in the VR space includes an image 227′ of the straw 227 as well as an image 229′ of the drinking cup 229 that holds the straw 227. The rendering algorithm may determine the type of object having the identifiable marker and based on the type may include image(s) of additional object(s), such as an image of a cup with the straw, when rendering the object with the identifiable marker in the VR space. The images 227′ of the straw 227 and of the drinking cup 229′ are VR generated images and are rendered in the interactive zone 231′″.

Various embodiments have been described with reference to rendering images of objects for user interaction based on their location in relation to a visual field of view of a user wearing the HMD. These images may be VR generated or may be actual real-world objects as seen through a portion of the display screen of the HMD that has transitioned to a transparent view. In alternate embodiments, location of objects within the real-world space may be identified using binaural three-dimensional (3D) audio rendering technique. In one embodiment, binaural 3D audio rendering is implemented in the HMD by using two specially designed microphones (simulating the two ears of a user) to record sounds originating in the real-world space. When the sounds captured by these microphones are played back to the user via each ear, the user is able to determine location of origin of each captured sound (i.e., an object that is emitting the sound). Using this binaural 3D audio rendering technique, the user may be able to locate the object in the real-world space even if the object is not in the field of view and even when the object is not making any noise in the real world at the time of user interaction. For example, a mobile phone could emit a virtual binaural 3D audio sound that is captured by the microphones of the HMD. When the recorded audio is played back to the user, the user is able to determine the location of the mobile phone in the real-world space by just using the audio signal, even when the mobile phone is not in the field of view of the user and, in fact, may be behind the user in the real-world space. It should therefore be understood that the objects in the real-world space may be located not only through visual rendition of virtual images provided in the VR space but also through virtual aural signals captured by the microphones of the HMD. Further, the various embodiments are not restricted to just these two types of techniques for locating objects in the real-world space but can use other techniques to determine the location of the objects in the real-world space while the user is interacting with the content from the VR space.

FIG. 5F illustrates another embodiment, wherein the selected object is a cell phone 221 and the image of the selected object rendered in the VR space is that of a VR generated image 221′ of cell phone and any companion object (e.g., VR generated image 223′ of TV remote control) that is in the vicinity of the cell phone 221′. The images rendered in the interactive zone 231″″ is of the selected object and the companion object (i.e., cell phone 221′ and the TV remote control 223′) are VR generated images.

FIG. 5G illustrates an embodiment that is used to alert the user of some impending obstacle, in one embodiment of the invention. As the user is moving around in the physical space of the real-world environment while interacting with the content rendering on the HMD 104, the user may be interested in interacting with an object in the field of view. The object that is in the field of view is a drinking cup 229 (with no identifiable markers) holding a straw 227 (with identifiable marker element). In this case, only an image 227′ of the straw 227 is rendered in the VR space and the user may interact with the drinking cup using the VR image 227′ of the straw 227. As the user is fully engrossed in the content and with the selected object, the user may inadvertently get closer to another object (e.g., a vase, etc.) or obstacle, such as a wall, a door, a car, another person, a sofa, a chair, etc., and be unaware of the potential danger in the proximity of the user. In order to prevent the user from walking into the obstacle or from getting hurt, alerts may be provided on the screen of the HMD 104 warning the user of the potential danger. FIG. 5G illustrates one such embodiment, wherein the user is moving toward the wall. The camera 108 may track the position of the user and detect that the user is moving towards an obstacle. The HMD 104 may use the images from the camera 108 and render a VR image of a user walking towards the obstacle, in an interactive zone 233 in the VR space currently rendering on the HMD 104. When the user gets closer to the wall, the radar or ultrasonic component of the proximity sensors in the HMD 104 may detect the proximity of the user to the wall and in response, generate a zone or halo around the VR generated image of the user's face or of the user and update this VR generated image of the user's face with the halo in the interactive zone 233 rendered on the HMD 104. In addition to the user image, the HMD 104 may also provide a VR generated image of the obstacle, such as the wall, that the user is approaching in the interactive zone 233. Intensity of the halo may be increased or other signals, including audio signal, haptic signal, etc., may be generated with intensity increasing to alert the user that the user is walking into the wall or other obstacle. In some embodiments, if the user continues to walk toward the wall, the display screen of the HMD 104 may be opened up to transparent view so that the user can view the user's position in relation to the wall. In some embodiments, one or more cameras on the HMD 104 may be used to determine the user's proximity in relation to the obstacle and provide the halo image at the display screen of the HMD. For more details about transitioning a portion of the screen of the HMD 104 to transparent view, reference can be made to application Ser. No. 14/254,881, filed on Apr. 16, 2014, and entitled, “Systems and Methods for Transitioning Between Transparent Mode and Non-Transparent Mode in a Head Mounted Display”, which is incorporated herein by reference in its entirety.

In one embodiment, transitioning a portion of the screen of the HMD may be enabled based on input provided by the user. For example, the user wearing the HMD 104 may provide a hand gesture. The HMD 104 may interpret the hand gesture and adjust the screen of the HMD 104 to transition at least a portion of the display screen from an opaque view to transparent view or vice versa depending on the state of the display screen. For example, the user may provide a swipe gesture in front of the HMD and this swipe gesture may be interpreted by the HMD 104 to open the portion of the screen of the HMD to transparent mode, if the display screen is operating in an opaque mode. In some implementations, the swipe gesture may be interpreted to determine swipe attributes, such as direction of swipe, area covered by swipe (e.g., left side, right side, top side, bottom side, diagonal, etc.), etc., and use the swipe attributes to transition corresponding portion of the screen of the HMD to transparent mode. A subsequent swipe gesture may be used to transition the display screen from the transparent mode to opaque mode. For example, when the swipe gesture is a upward swipe, the HMD 104 transitions the display screen to transparent view and the downward swipe may be used to revert the display screen to opaque mode. Alternately, a gesture from the middle of the display screen outward laterally or vertically may cause the display screen to be transitioned to transparent view in the direction of the gesture while an inward gesture laterally or vertically would cause the display screen to be transitioned to opaque view. Alternately, once the display screen is in transparent mode, subsequent similar gesture that opened the display screen to transparent mode may be used to transition the display screen to opaque mode. In other embodiments, a single clap, a double clap or a voice command may be used to transition the display screen to transparent mode and a subsequent single clap, double clap or voice command may be used to revert the display screen to opaque mode. The ultrasonic component of the HMD and/or the camera of the HMD is configured to sense the gesture in front of the HMD and to adjust the mode of the screen of the HMD accordingly. In some embodiments, the swipe gesture may involve the user providing input by touching the screen of the HMD.

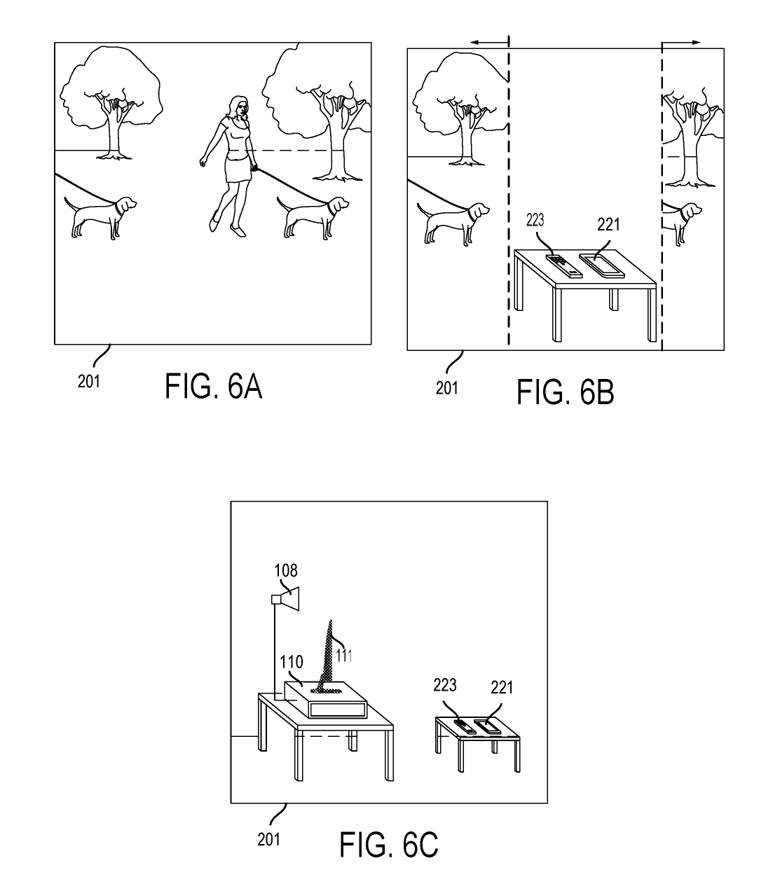

FIGS. 6A-6C illustrate an example embodiment in which a swipe gesture is used to open the display screen of the HMD from an opaque mode to transparent mode. FIG. 6A illustrates a view of content from the VR space that is currently rendering on the display screen of the HMD 104 while the display screen is in opaque mode. In one embodiment, a swipe gesture is detected in front of the display screen of the HMD 104. The swipe gesture may be an upward swipe gesture, a side swipe, or a swipe beginning from the middle and moving outward. In an alternate embodiment, a voice command or an audio gesture, such as a single clap, double clap, etc., may be detected near the HMD 104 instead of the swipe gesture. The HMD 104 may react to the gesture or audio command by transitioning the display screen from an opaque mode to transparent mode. FIG. 6B illustrates the transition in progress, wherein a middle portion of the display screen has transitioned to the transparent mode and is rendering content (cell phone 221, remote control 223 on a table) from the real-world environment in the vicinity of the user. The remaining portions of the display screen (i.e., the right portion and the left portion) are still in opaque mode. FIG. 6C illustrates a view of content that is being rendered on the display screen of the transition mode after the transition to transparent mode has completed. The view of the real-world environment that is rendered in FIG. 6C is from the perspective of the user wearing the HMD 104.

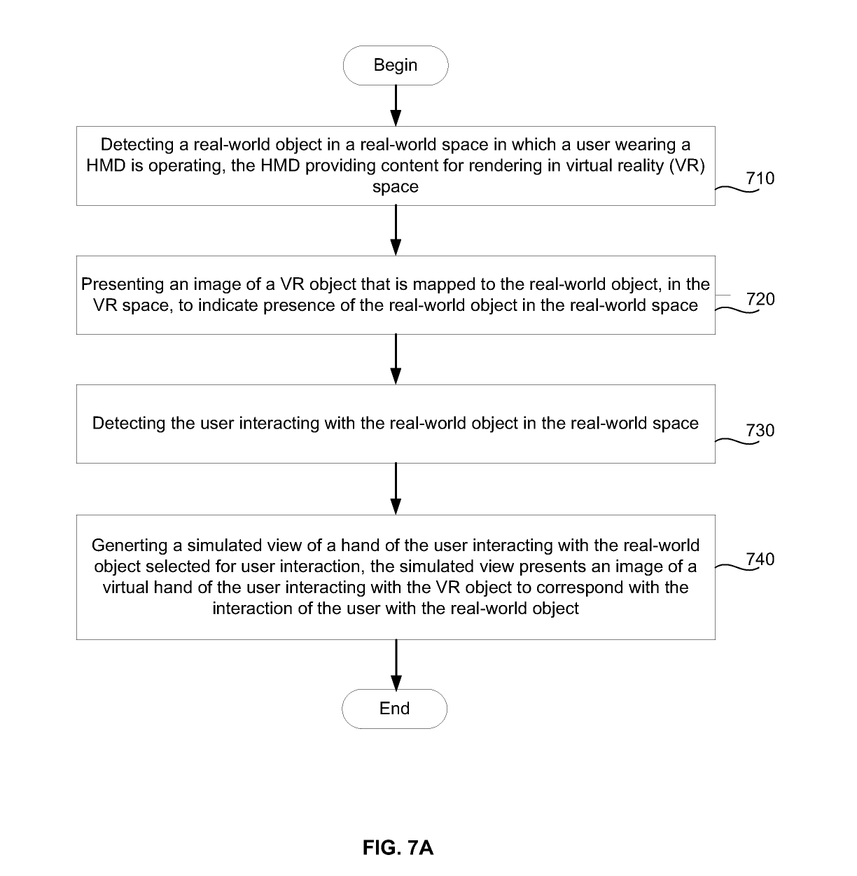

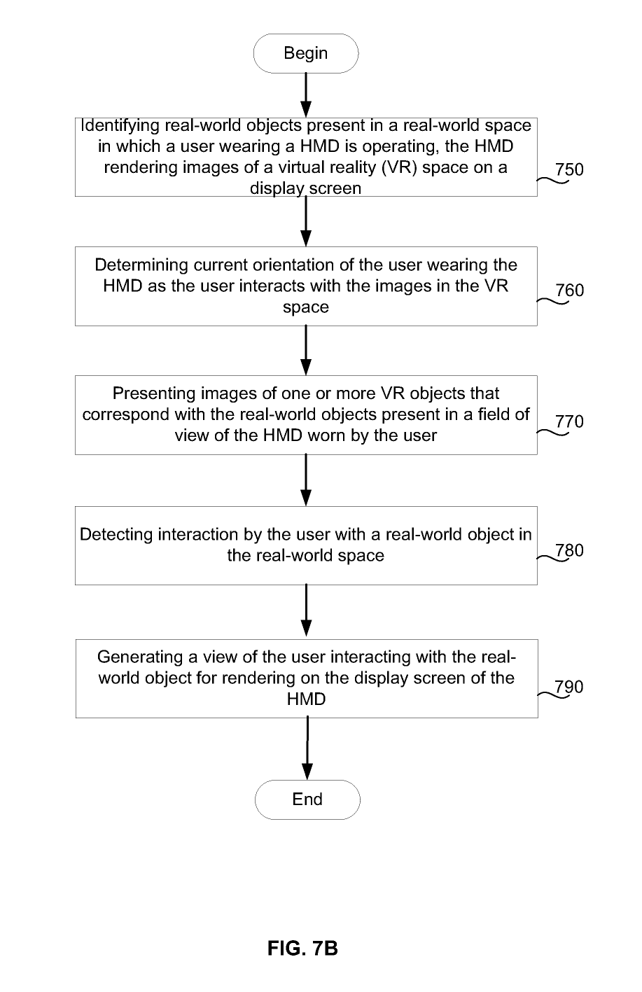

FIG. 7A illustrates a flow of operations of a method, in one embodiment of the invention. The method begins at operation 710, wherein a real-world object is identified in a real-world space in which a user wearing a head mounted display is interacting with a virtual reality (VR) space. The real-world object is identified using an indicator of the real-world object. The indicator may be provided on the outside (e.g., QR code, bar code, marker element, indicator, etc.) or on the inside (e.g., RFID tags). The HMD is configured to present images of the VR space on a display screen of the HMD. An image of a VR object that is mapped to the real-world object detected in the real-world space, is presented in the VR space, as illustrated in operation 720. The image of the VR object is provided to indicate presence of the real-world object while interacting with the VR space. Interaction by the user with the real-world object is detected, as illustrated in operation 730. The interaction may include a hand of a user moving toward the object, the hand of the user touching the object, etc. In response to detecting the user interaction, a simulated view of a hand of the user interacting with the real-world object is generated for rendering on the display screen of the HMD. The simulated view that is generated includes an image of a virtual hand of the user interacting with the VR object that corresponds to the hand of the user interacting with the real-world object.

FIG. 7B illustrates flow of operations of an alternate method, in accordance to embodiment. The method begins with the identification of real-world objects that are present in a real-world space in which a user wearing a head mounted display (HMD) is operating, as illustrated in operation 750. The HMD is configured to present images of a virtual reality (VR) space (e.g., interactive scenes of a video game or streaming content of an interactive application, etc.) on a display screen of the HMD. The identification of the real-world objects include determining location and orientation of each of the real-world objects in the real-world space. Current orientation of the user wearing the HMD is determined as the user interacts with the images in the VR space, as illustrated in operation 760. As the user interacts with the VR space, the user may move around in the real-world space. As a result, a field of view of the user wearing the HMD may be change based on the movement of the user while interacting in the VR space.

Based on the current orientation of the user, images of one or more VR objects that correspond with specific ones of the real-world objects identified in the real-world space that are in the field of view of the user are presented in the VR space of the HMD, as illustrated in operation 770. As the user continues to move while interacting with the content rendered in the VR space, the field of view of the user continues to change due to change in position and/or orientation of the HMD worn by the user. As a result, the real-world objects that are in the field of view also change. Such changes are detected by the HMD and the images of the VR objects presented in the VR space are updated to render images of the VR objects that correspond with specific ones of the real-world objects that are in the field of view of the HMD.

User interaction at a specific real-world object in the real-world space is detected, as illustrated in operation 780, and in response, a view of the user interacting with the real-world object is generated for rendering on the display screen of the HMD, as illustrated in operation 790. The view may be generated based on type of object selected for interaction and type of interaction on the selected object. Thus, in order to determine the view that is to be generated, the type of the selected object and the type of interaction on the selected object may be evaluated and based on the evaluation either a simulated view of a virtual hand of the user interacting with an image of a VR object corresponding to the real-world object is generated or a view to a real-world space is presented on the VR screen.

The various embodiments describe ways by which a user wearing a HMD can interact with real-world objects while fully immersed in the content of the VR space that is rendered on the HMD. The user does not have to remove the HMD in order to interact. Prior to the current embodiments, when a user needed to interact with a real-world object, the user had to manually pause the video game rendering on the HMD, remove the HMD, locate the real-world object, interact with the real-world object, wear the HMD and manually re-start the video game. This affected the game play experience of the user. In order to avoid affecting the game play experience for the user, the embodiments provide ways in which the user is able to interact with the real-world object while continuing to immerse in game play. The images of the real-world objects are presented to include depth in relation to the user so as to allow the user to determine the position of the object and to reach out to the real-world object without hindering the user's game play experience. When the video game is a single-user game, the game play may automatically pause or slow down to allow the user to interact with the object. The game play may be resumed upon detecting the user's completion of interaction with the object. When the video game is a multi-user game, the embodiments allow the user to interact with a selected object while immersed in game play. Other advantages will become obvious to one skilled in the art.

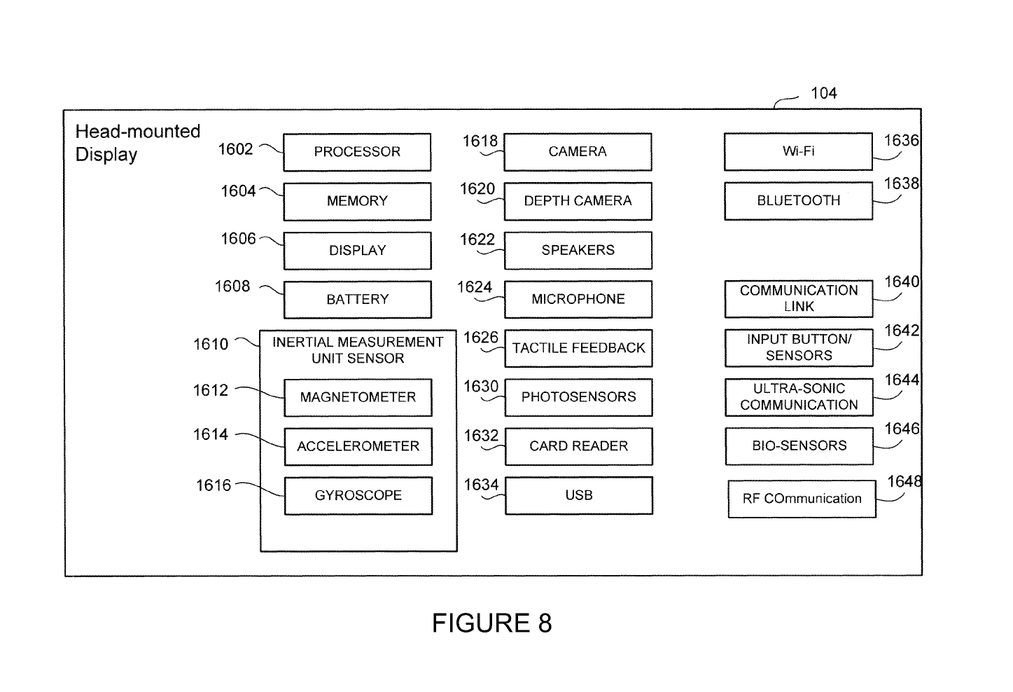

FIG. 8 illustrates example components of an HMD 104, in accordance with an embodiment described in the present disclosure. It should be understood that more or less components can be included or excluded from the HMD 104, depending on the configuration and functions enabled. The HMD 104 includes a processor 1602 for executing program instructions stored in memory 1604. The memory device 1604 of the HMD 104 is provided for storage purposes for various programs and data and, in one embodiment, includes both volatile and non-volatile memory.

A display 1606 is included within the HMD 104 to provide a visual interface for viewing virtual reality (VR) content provided by an interactive application. In some embodiments, the visual interface of the display 1606 may also be configured to provide a view of the physical space in which the user wearing the HMD is operating. The display 1606 is defined by one single display screen, or may be defined by a separate display screen for each eye of the user 102. When two display screens are provided, it is possible to provide left-eye and right-eye video content separately. Separate presentation of video content to each eye, for example, provides for better immersive control of 3D content. In one embodiment wherein two display screens are provided in the HMD 104, the second screen is provided with second screen content by using the content provided for one eye, and then formatting the content for display in a two-dimensional (2D) format. The content for one eye, in one embodiment, is the left-eye video feed, but in other embodiments is the right-eye video feed.

A battery 1608 is provided as a power source for the HMD 104. In other embodiments, the power source includes an outlet connection to power. In other embodiments, an outlet connection to power and the battery 1608 are both provided. An Inertial Measurement Unit (IMU) sensor module 1610 includes any of various kinds of motion sensitive hardware, such as a magnetometer 1612, an accelerometer 1614, and a gyroscope 1616 to measure and report specific force, angular rate and magnetic field of the HMD 104. The magnetometers 1612, accelerometers 1614 and gyroscopes are part of the position and orientation measurement devices of the HMD 104. In addition to the aforementioned sensors, additional sensors may be provided in the IMU sensor module 1610. Data collected from the IMU sensor module 1610 allows a computing device to track the user, the real-world objects, the HMD 104 and the hand-held controller 106 position in the physical space in which the user wearing the HMD 104 is operating.

A magnetometer 1612 measures the strength and direction of the magnetic field in the vicinity of the HMD 104. In one embodiment, three magnetometers are used within the HMD 104, ensuring an absolute reference for the world-space yaw angle. In one embodiment, the magnetometer 1612 is designed to span the earth magnetic field, which is ±80 microtesla. Magnetometers are affected by metal, and provide a yaw measurement that is monotonic with actual yaw. The magnetic field is warped due to metal in the environment, which causes a warp in the yaw measurement. If necessary, this warp is calibrated using information from other sensors such as the gyroscope, or the camera.

In one embodiment, an accelerometer 1614 is used together with magnetometer 1612 to obtain the inclination and azimuth of the HMD 104. The accelerometer 1614 is a device for measuring acceleration and gravity induced reaction forces. Single and multiple axis (e.g., six-axis) models are able to detect magnitude and direction of the acceleration in different directions. The accelerometer 1614 is used to sense inclination, vibration, and shock. In one embodiment, three accelerometers are used to provide the direction of gravity, which gives an absolute reference for two angles (world-space pitch and world-space roll).

A gyroscope 1616 is a device for measuring or maintaining orientation, based on the principles of angular momentum. In one embodiment, three gyroscopes provide information about movement across the respective axis (x, y and z) based on inertial sensing. The gyroscopes help in detecting fast rotations. However, the gyroscopes drift overtime without the existence of an absolute reference. To reduce the drift, the gyroscopes are reset periodically, which can be done using other available information, such as positional/orientation determination based on visual tracking of an object, accelerometer, magnetometer, etc.

A camera 1618 is provided for capturing images and image streams of the real-world environment. In one embodiment, more than one camera (optionally) is included in the HMD 104, including a camera that is rear-facing (directed away from the user when the user is viewing the display of the HMD 104), and a camera that is front-facing (directed towards the user when the user is viewing the display of the HMD 104). Additional cameras may be disposed along the sides of the HMD to provide a broader view (e.g., 360° view) of the physical space surrounding the HMD 104. Additionally, in an embodiment, a depth camera 1620 is included in the HMD 104 for sensing depth information of objects in the real-world environment. In addition to the cameras 1618 and 1620, additional one or more cameras may be disposed in the HMD 104 to capture user attributes by orienting the additional cameras toward the user's face or eyes.

The HMD 104 includes speakers 1622 for providing audio output. Also, in one embodiment, a microphone 1624 is included for capturing audio from the real-world environment, including sounds from the ambient environment, speech made by the user, etc. In an embodiment, the HMD 104 includes tactile feedback module 1626 for providing tactile feedback to the user 102. In one embodiment, the tactile feedback module 1626 is capable of causing movement and/or vibration of the HMD 104 so as to provide tactile feedback to the user. In specific embodiments, the tactile feedback may be provided to alert or warn the user of an obstacle or danger that may be present in the real-world environment based on the user's position.

Photosensors 1630 are provided to detect one or more light beams. A card reader 1632 is provided to enable the HMD 104 to read and write information to and from a memory card. A USB interface 1634 is included as one example of an interface for enabling connection of peripheral devices, or connection to other devices, such as other portable devices, computers, game consoles, etc. In various embodiments of the HMD 104, any of various kinds of interfaces may be included to enable greater connectivity of the HMD 104.

In an embodiment, a Wi-Fi module 1636 is included for enabling connection to the computer network via wireless networking technologies. Also, in one embodiment, the HMD 104 includes a Bluetooth module 1638 for enabling wireless connection to other devices. A communications link 1640 is included for connection to other devices. In one embodiment, the communications link 1640 utilizes infrared transmission for wireless communication. In other embodiments, the communications link 1640 utilizes any of various wireless or wired transmission protocols for communication with other devices.

Input buttons/sensors 1642 are included to provide an input interface for the user. Any of various kinds of input interfaces may be included, such as buttons, gestures, touchpad, joystick, trackball, etc. In one embodiment, an ultra-sonic communication module 1644 is included in HMD 104 for facilitating communication with other devices via ultra-sonic technologies.

In an embodiment, bio-sensors 1646 are included to enable detection of physiological data from the user 102. In one embodiment, the bio-sensors 1646 include one or more dry electrodes for detecting bio-electric signals of the user through the user's skin, voice detection, eye retina detection to identify users/profiles, etc. In an embodiment, RF communication module 1648 with a tuner is included for enabling communication using radio frequency signals and/or radar signals.

The foregoing components of HMD 104 have been described as merely exemplary components that may be included in HMD 104. In various embodiments described in the present disclosure, the HMD 104 may or may not include some of the various aforementioned components. Embodiments of the HMD 104 may additionally include other components not presently described, but known in the art, for purposes of facilitating aspects of the present invention as herein described.

In one embodiment, the HMD 104 includes light emitting diodes, which are used in addition to the photosensors 1630 to determine a position and/or orientation of the HMD 104. For example, the LEDs and a camera located within the environment in which the HMD 104 is located are used to confirm or deny a position and/or orientation of the HMD 104 that are determined using the photosensors 1630.

It will be appreciated by those skilled in the art that in various embodiments described in the present disclosure, the aforementioned HMD is utilized in conjunction with a handheld device, such as a controller, and an interactive application displayed on a display to provide various interactive functions. The exemplary embodiments described herein are provided by way of example only, and not by way of limitation.

In one embodiment, clients and/or client devices, as referred to herein, may include HMDs, terminals, laptop computers, personal computers, game consoles, tablet computers, general purpose computers, special purpose computers, mobile computing devices, such as cellular phones, handheld game playing devices, etc., set-top boxes, streaming media interfaces/devices, smart televisions, kiosks, wireless devices, digital pads, stand-alone devices, and/or the like that are capable of being configured to fulfill the functionality of a client as defined herein. Typically, clients are configured to receive encoded video streams, decode the video streams, and present the resulting video to a user, e.g., interactive scenes from a game to a player of the game. The processes of receiving encoded video streams and/or decoding the video streams typically includes storing individual video frames in a receive buffer of the client. The video streams may be presented to the user 102 on a display of the HMD 104 or on a display integral to client or on a separate display device such as a monitor or television communicatively coupled to the client.

Clients are optionally configured to support more than one game player. For example, a game console may be configured to support a multiplayer game in which more than one player (e.g., P1, P2, . . . Pn) has opted to play the game at any given time. Each of these players receives or shares a video stream, or a single video stream may include regions of a frame generated specifically for each player, e.g., generated based on each player's point of view. The clients are either co-located or geographically dispersed. The number of clients included in a game system varies widely from one or two to thousands, tens of thousands, or more. As used herein, the term “game player” is used to refer to a person that plays a game and the term “game playing device” is used to refer to a computing device that is used to play a game. In some embodiments, the game playing device may refer to a plurality of computing devices that cooperate to deliver a game experience to the user.

For example, a game console and an HMD cooperate with a video server system to deliver a game viewed through the HMD. In one embodiment, the game console receives the video stream from the video server system and the game console forwards the video stream, or updates to the video stream, to the HMD and/or television for rendering. In an alternate embodiment, the HMD cooperates with a game console to receive and render content of a game executing on the game console. In this embodiment, the video stream of the game is transmitted by the game console to the HMD for rendering.

An HMD is used for viewing and/or interacting with any type of content produced or used, such as video game content, movie content, video clip content, web content, weblogs, advertisement content, contest content, gambling game content, meeting content, social media content (e.g., postings, messages, media streams, friend events and/or game play), video portions and/or audio content, and content made for consumption from sources over the internet via browsers and applications, and any type of streaming content. Of course, the foregoing listing of content is not limiting, as any type of content can be rendered so long as it can be viewed in the HMD or rendered to a screen of the HMD.

In one embodiment, clients further include systems for modifying received video. In one embodiment, the video is modified to generate augmented reality content. For example, a client may perform an overlay of one video image on another video image, image of a real-world object over a video image, crop a video image, and/or the like. In one embodiment, the real-world object is provided as an overlay in a “ghost” format, wherein a ghost-like image of the real-world object is presented over the video image. In another embodiment, the real-world object may be provided as a wired outline over the video image. The aforementioned format of presenting the real-world object over a video image may be extended to overlaying of one video image on another video image. The aforementioned formats are provided as examples and that other forms of modifying the video may also be engaged.

In another example, clients receive various types of video frames, such as I-frames, P-frames and B-frames, and to process these frames into images for display to a user. In some embodiments, number of clients is configured to perform further rendering, sharing, conversion to 3-D, conversion to 2D, distortion removal, sizing, or like operations on the video stream. A number of clients is optionally configured to receive more than one audio or video stream.

The controller 106 includes, for example, a one-hand game controller, a two-hand game controller, a gesture recognition system, a gaze recognition system, a voice recognition system, a keyboard, a joystick, a pointing device, a force feedback device, a motion and/or location sensing device, a mouse, a touch screen, a neural interface, a camera, input devices yet to be developed, and/or the like.

In some embodiments, a video source includes rendering logic, e.g., hardware, firmware, and/or software stored on a computer readable medium such as storage. This rendering logic is configured to create video frames of the video stream based on the game state, for example. All or part of the rendering logic is optionally disposed within one or more graphics processing unit (GPU). Rendering logic typically includes processing stages configured for determining the three-dimensional spatial relationships between real-world objects, between real-world objects and user, and/or for applying appropriate textures, etc., based on the game state and viewpoint. The rendering logic produces raw video that is encoded. For example, the raw video is encoded according to an Adobe Flash® standard, HTML-5, .wav, H.264, H.263, On2, VP6, VC-1, WMA, Huffyuv, Lagarith, MPG-x, Xvid, FFmpeg, x264, VP6-8, real video, mp3, or the like. The encoding process produces a video stream that is optionally packaged for delivery to a decoder on a device, such as the HMD 104. The video stream is characterized by a frame size and a frame rate. Typical frame sizes include 800×600, 1280×720 (e.g., 720p), 1024×768, 1080p, although any other frame sizes may be used. The frame rate is the number of video frames per second. In one embodiment, a video stream includes different types of video frames. For example, the H.264 standard includes a “P” frame and an “I” frame. I-frames include information to refresh all macro blocks/pixels on a display device, while P-frames include information to refresh a subset thereof. P-frames are typically smaller in data size than are I-frames. As used herein the term “frame size” is meant to refer to a number of pixels within a frame. The term “frame data size” is used to refer to a number of bytes required to store the frame.

In one embodiment, a cloud gaming server is configured to detect the type of client device (e.g., computing device 110, HMD 102, etc.) which is being utilized by the user, and provide a cloud-gaming experience appropriate to the user's client device. For example, image settings, audio settings and other types of settings may be optimized for the user's client device.

In one embodiment, the HMD 104 is used to render images of a virtual reality (VR) space of a video game, wherein images of VR objects that correspond with real-world objects are introduced into the VR space. The user is allowed to interact with the real-world object using the images of the VR objects rendered in the VR space while the user is interacting with content presented in the VR space. In some embodiments, user interactions with the real-world object cause a portion of a display screen of the HMD 104 to transition to a transparent view so as to allow the user to view the real-world object during his/her interaction with the real-world object.

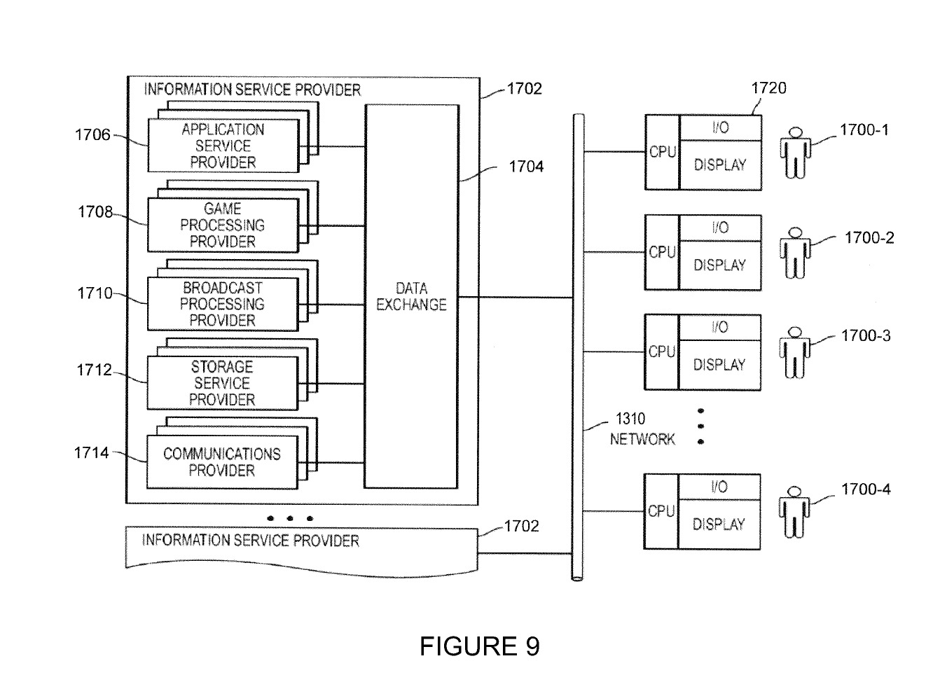

FIG. 9 illustrates an embodiment of an Information Service Provider architecture that is used to provide content for rendering on the HMD 104. Information Service Providers (ISP) 1702 delivers a multitude of information services to users 1700-1, 1700-2, 1700-3, 1700-4, etc., geographically dispersed and connected via the computer network 1310. It should be noted that instead of any of the users 1700-1, or 1700-2, or 1700-3, and 1700-4, the user 102 receives the multitude of information services. In one embodiment, an ISP delivers one type of service, such as stock price updates, or a variety of services such as broadcast media, news, sports, gaming, etc. Additionally, the services offered by each ISP are dynamic, that is, services can be added or taken away at any point in time. Thus, the ISP providing a particular type of service to a particular individual can change over time. For example, a user is served by an ISP in near proximity to the user while the user is in her home town, and the user is served by a different ISP when the user travels to a different city. The home-town ISP will transfer the required information and data to the new ISP, such that the user information “follows” the user to the new city making the data closer to the user and easier to access. In another embodiment, a master-server relationship is established between a master ISP, which manages the information for the user, and a server ISP that interfaces directly with the user under control from the master ISP. In another embodiment, the data is transferred from one ISP to another ISP as the client moves around the world to make the ISP in better position to service the user be the one that delivers these services.

ISP 1702 includes Application Service Provider (ASP) 1706, which provides computer-based services to customers over the computer network 1310. Software offered using an ASP model is also sometimes called on-demand software or software as a service (SaaS). A simple form of providing access to a particular application program (such as customer relationship management) is by using a standard protocol such as HTTP. The application software resides on the vendor's system and is accessed by users through a web browser using HTML, by special purpose client software provided by the vendor, or other remote interface such as a thin client.

Services delivered over a wide geographical area often use cloud computing. Cloud computing is a style of computing in which dynamically scalable and often virtualized resources are provided as a service over the computer network 1310. Users do not need to be an expert in the technology infrastructure in the “cloud” that supports them. In one embodiment, cloud computing are divided in different services, such as Infrastructure as a Service (IaaS), Platform as a Service (PaaS), and Software as a Service (SaaS). Cloud computing services often provide common business applications online that are accessed from a web browser, while the software and data are stored on the servers. The term cloud is used as a metaphor for the Internet (e.g., using servers, storage and logic), based on how the Internet is depicted in computer network diagrams and is an abstraction for the complex infrastructure it conceals.

Further, ISP 1702 includes a Game Processing Server (GPS) 1708 which is used by game clients to play single and multiplayer video games. Most video games played over the Internet operate via a connection to a game server. Typically, games use a dedicated server application that collects data from players and distributes it to other players. This is more efficient and effective than a peer-to-peer arrangement, but it requires a separate server to host the server application. In another embodiment, the GPS establishes communication between the players and their respective game-playing devices exchange information without relying on the centralized GPS.

Dedicated GPSs are servers which run independently of the client. Such servers are usually run on dedicated hardware located in data centers, providing more bandwidth and dedicated processing power. Dedicated servers are the preferred method of hosting game servers for most PC-based multiplayer games. Massively multiplayer online games run on dedicated servers usually hosted by the software company that owns the game title, allowing them to control and update content.

Broadcast Processing Server (BPS) 1710 distributes audio or video signals to an audience. Broadcasting to a very narrow range of audience is sometimes called narrowcasting. The final leg of broadcast distribution is how the signal gets to the listener or viewer, and it may come over the air as with a radio station or TV station to an antenna and receiver, or may come through cable TV or cable radio (or “wireless cable”) via the station or directly from a network. The Internet may also bring either radio or TV to the recipient, especially with multicasting allowing the signal and bandwidth to be shared. Historically, broadcasts have been delimited by a geographic region, such as national broadcasts or regional broadcast. However, with the proliferation of fast internet, broadcasts are not defined by geographies as the content can reach almost any country in the world.

Storage Service Provider (SSP) 1712 provides computer storage space and related management services. SSPs also offer periodic backup and archiving. By offering storage as a service, users can order more storage as required. Another major advantage is that SSPs include backup services and users will not lose all their data if their computers' hard drives fail. Further, in an embodiment, a plurality of SSPs have total or partial copies of the user data, allowing users to access data in an efficient way independently of where the user is located or the device being used to access the data. For example, a user can access personal files in the home computer, as well as in a mobile phone while the user is on the move.

Communications Provider 1714 provides connectivity to the users. One kind of Communications Provider is an Internet Service Provider (ISP) which offers access to the Internet. The ISP connects its customers using a data transmission technology appropriate for delivering Internet Protocol datagrams, such as dial-up, DSL, cable modem, fiber, wireless or dedicated high-speed interconnects. The Communications Provider can also provide messaging services, such as e-mail, instant messaging, and SMS texting. Another type of Communications Provider is the Network Service provider (NSP) which sells bandwidth or network access by providing direct backbone access to the Internet. Network service providers, in one embodiment, include telecommunications companies, data carriers, wireless communications providers, Internet service providers, cable television operators offering high-speed Internet access, etc.

Data Exchange 1704 interconnects the several modules inside ISP 1702 and connects these modules to users 1700 via the computer network 1310. Data Exchange 1704 covers a small area where all the modules of ISP 1702 are in close proximity, or covers a large geographic area when the different modules are geographically dispersed. For example, Data Exchange 1788 includes a fast Gigabit Ethernet (or faster) within a cabinet of a data center, or an intercontinental virtual area network (VLAN).

Users 1700 access the remote services with client device 1720, which includes at least a CPU, a display and an input/output (I/O) device. The client device can be a personal computer (PC), a mobile phone, a netbook, tablet, gaming system, a personal digital assistant (PDA), etc. In one embodiment, ISP 1702 recognizes the type of device used by the client and adjusts the communication method employed. In other cases, client devices use a standard communications method, such as html, to access ISP 1702.

Embodiments described in the present disclosure may be practiced with various computer system configurations including hand-held devices, microprocessor systems, microprocessor-based or programmable consumer electronics, minicomputers, mainframe computers and the like. The embodiments described in the present disclosure can also be practiced in distributed computing environments where tasks are performed by remote processing devices that are linked through a wire-based or wireless network.

With the above embodiments in mind, it should be understood that the embodiments described in the present disclosure can employ various computer-implemented operations involving data stored in computer systems. These operations are those requiring physical manipulation of physical quantities. Any of the operations described herein that form part of the embodiments described in the present disclosure are useful machine operations. Some embodiments described in the present disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Some embodiments described in the present disclosure can also be embodied as computer readable code on a computer readable medium. The computer readable medium is any data storage device that can store data, which can be thereafter be read by a computer system. Examples of the computer readable medium include a hard drive, a NAS, a ROM, a RAM, a CD-ROM, a CD-R, a CD-RW, a magnetic tape, an optical data storage device, a non-optical data storage device, etc. The computer readable medium can include computer readable tangible medium distributed over a network-coupled computer system so that the computer readable code is stored and executed in a distributed fashion.

It should be noted that in some embodiments, any of the embodiments described herein are combined with any of the remaining embodiments.

Moreover, although some of the above-described embodiments are described with respect to a gaming environment, in some embodiments, instead of a game, other environments, e.g., a video conferencing environment, etc., is used.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments described in the present disclosure have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein.

1. A method for interacting with a virtual reality space using a head mounted display, comprising:
detecting a real-world object in a real-world space in which a user is interacting with the virtual reality (VR) space rendered on a display screen of the head mounted display (HMD), the real-world object identified using an indicator disposed thereon;
presenting, in the VR space, an image of a VR object that is mapped to the real-world object, the image of the VR object being provided to indicate presence of the real-world object in the real-world space while the user is interacting with the VR space;
detecting the user interacting with the real-world object in the real-world space; and
generating a simulated view of a hand of the user interacting with the real-world object by presenting an image of a virtual hand of the user interacting with the VR object that corresponds to the hand of the user interacting with the real-world object, the simulated view being presented on the display screen of the HMD while the user is interacting in the VR space.

2. The method of claim 1, wherein the image of the VR object being presented in the VR space is based on location of the real-world object in relation to an orientation of the user wearing the HMD.

3. The method of claim 1, further includes transitioning a portion of the display screen of the HMD to a transparent view when the real-world object that the user is interacting with is at a distance from the user that is less than a predefined threshold value, the transition allowing the user to view the real-world object during interaction, wherein the portion of the display screen that is transitioned correlates with a location of the real-world object as viewed through the HMD.

4. The method of claim 3, wherein the transitioning causes ceasing rendering of a portion of the image of the virtual hand of the user interacting with the VR object in the portion of the display screen that has transitioned to the transparent view.

5. The method of claim 1, further includes transitioning a portion of the display screen of the HMD to a transparent view, wherein the transitioning is performed based on a degree of interaction of the user detected at the real-world object, wherein the degree of interaction identifies a length of the interaction or an intensity of the interaction, and wherein the portion of the display screen that is transitioned correlates with a location of the real-world object as viewed through the HMD

6. The method of claim 1, wherein the real-world object is identified using an image capturing device that is mounted on the HMD and is facing outward, wherein the image capturing device of the HMD is one of a stereoscopic camera or an infrared camera or an RGB camera.

7. The method of claim 1, wherein the real-world object is identified using an external camera disposed in the real-world space, the external camera being one of an RGB camera, an infrared camera, or a stereoscopic camera.

8. The method of claim 1, wherein the indicator is a marker element disposed on an external surface of the real-world object for visual tracking, the marker element providing information to identify the real-world object, and
wherein presenting an image of the VR object includes presenting a floating image of the VR object in the VR space, the floating image of the VR object is configured to adjust in accordance to movement of the user in the real-world space.

9. The method of claim 1, wherein detecting the user interaction further includes detecting movement of the hand of the user toward the real-world object, wherein the movement of the hand detected using an image capturing device mounted on the HMD, or an external camera disposed in the real-world space, or by one or more sensors disposed on the HMD.

10. The method of claim 9, wherein detecting the user interaction further includes detecting a second hand of the user moving toward the real-world object, the movement of the second hand detected using the image capturing device mounted on the HMD, or the external camera disposed in the real-world space, or by one or more sensors disposed on the HMD.

11. The method of claim 1, wherein detecting the user interaction further includes detecting the hand of the user touching the real-world object, the touching detected based on a signal generated by a touch sensor located on the real-world object.

12. The method of claim 1, wherein detecting the user interaction further includes detecting the hand of the user pressing a button on the real-world object or detecting the user interacting with a touch-screen interface on the real-world object.

13. The method of claim 1, wherein interaction of the user with the real-world object further includes,
evaluating a type of interaction by the user and an object type of the real-world object that the user is interacting with in the real-world space;
computing a distance of the real-world object in relation to the user, in response to detecting user interaction with the real-world object; and
transitioning a portion of the display screen of the HMD to a transparent view, when the computed distance of the real-world object from the user is less than a pre-defined threshold value, the transitioning is based on the type of the user interaction and the object type of the real-world object,
wherein the portion of the display screen that is transitioned correlates with a location and orientation of the real-world object viewed through the HMD.

14. The method of claim 1, further includes detecting additional real-world objects in the real-world space and presenting images of VR objects that are mapped to respective ones of the additional real-world objects on the display screen of the HMD,
wherein presenting the images includes,
detecting a field of view of the HMD worn by the user, the field of view being dynamically adjusted to correlate with the movement of the HMD worn by the user; and
presenting, in the VR space, the images of the VR objects corresponding to select ones of the real-world objects that are in the field of view of the HMD, for user interaction, the images of the VR objects presented in the VR space dynamically adjusted in accordance to change in the field of view detected at the HMD.

15. The method of claim 1, wherein the simulated view highlights the VR object in response to detecting the user interaction with the real-world object.

16. The method of claim 1, wherein the real-world objects are objects that are used to receive or hold other real-world objects.

17. The method of claim 1, wherein images of content rendered in the virtual reality space is paused during interaction of the user with the real-world object and resumed upon detecting completion of the user interaction with the real-world object.

18. The method of claim 1, wherein the simulated view is presented as a floating image.

19. The method of claim 1, wherein the indicator is a passive marker element.

20. A method, comprising:
identifying real-world objects present in a real-world space in which a user wearing a head mounted display (HMD) is operating, the HMD is configured to present images of a virtual reality (VR) space on a display screen of the HMD, wherein the identifying includes determining location and orientation of each of the real-world objects in the real-world space;
determining current orientation of the user wearing the HMD as the user interacts with the images in the VR space;
presenting, in the VR space, images of one or more VR objects that correspond with the real-world objects present in a field of view of the HMD worn by the user, the images of the one or more VR objects presented in the VR space adjusted dynamically to correlate with a change in the field of view of the HMD worn by the user as the user continues to interact in the VR space;
detecting interaction by the user with a real-world object in the real-world space; and
in response to the detecting, generating a view of the user interacting with the real-world object for rendering on the display screen of the HMD.

21. The method of claim 20, wherein generating the view further includes evaluating a type of the real-world object selected for interaction and a type of interaction provided at the real-world object, wherein the view that is generated is in accordance to the evaluation.

22. The method of claim 21, wherein generating a view of the user interacting with the real-world object includes generating a simulated view, the simulated view providing an image of a virtual hand of the user interacting with a corresponding VR object that corresponds to a hand of the user interacting with the real-world object, the simulated view provided for rendering on the display screen of the HMD during user interaction with the images of the VR space.

23. The method of claim 21, wherein generating a view of the user interacting with the real-world object includes transitioning a portion of the display screen of the HMD to transparent mode to enable the user to view the real-world object in order to interact with the real-world object.

24. The method of claim 23, wherein transitioning a portion of the display screen further includes,
computing a distance of the real-world object in relation to the user, during user interaction with the real-object; and
transitioning the portion of the display screen of the HMD to a transparent view, when the computed distance of the real-world object from the user is less than a pre-defined threshold value, the transitioning is based on a type of interaction and an object type of the real-world object,
wherein the portion of the display screen that is transitioned correlates with a position of the real-world object in the field of view of the HMD.

25. The method of claim 24, wherein the transitioning causes ceasing rendering of a portion of the images from the VR space in the portion of the display screen that has transitioned to the transparent view.

26. The method of claim 20, wherein the real-world object is identified using a passive tag associated with the real-world object, the passive tag providing information to identify the real-world object.

27. A method, comprising:
identifying one or more real-world objects in a physical space in which a user wearing a head mounted display (HMD) is operating, the HMD is configured to present images from a virtual reality (VR) space on a display screen of the HMD;
presenting a list of the one or more real-world objects detected in the physical space on the display screen of the HMD during rendering of the images from the VR space;
detecting selection of a real-world object from the list for user interaction;
determining position of the real-world object in relation to a field of view of the HMD worn by the user;
presenting, in the VR space currently rendering on the display screen of the HMD, an image of a VR object that is mapped to the real-world object selected for user interaction, when the real-world object is in the field of view of the HMD, the image being presented to enable the user to determine location of the real-world object in relation to the user in the physical space;
detecting user interaction with the real-world object in the physical space; and
generating a simulated view of a hand of the user interacting with the real-world object by presenting an image of a virtual hand of the user interacting with the VR object that corresponds to the hand of the user interacting with the real-world object, the simulated view being presented on the display screen of the HMD while the user is interacting in the VR space.

28. The method of claim 27, wherein selection of the real-world object is detected from an input received from a controller communicatively connected to the HMD, an audio command, a gesture command, or combination of two or more thereof.

29. The method of claim 27, wherein when the real-world object is not in the field of view of the HMD worn by the user, presenting an informational message on the display screen of the HMD, the informational message providing details of a location of the real-world object in relation to the field of view of the HMD.

30. The method of claim 27, further includes transitioning a portion of the display screen of the HMD to a transparent view when the real-world object that the user is interacting with is at a distance from the user that is less than a predefined threshold value, the transition allowing the user to view the real-world object during interaction and the hand of the user used for interacting with the real-world object, wherein the portion of the display screen that is transitioned correlates with a location of the real-world object as viewed through the HMD.

31. The method of claim 30, wherein the transitioning causes ceasing rendering of a portion of the simulated view of the hand of the user interacting with the VR object in the portion of the display screen that has transitioned to the transparent view.
